(19) United States
(12) Patent Application Publication
(10) Pub. No.: US 2005/0284223 A1
(43) Pub. Date: Dec. 29, 2005

(54) Piezoelectric vibrating segment, supporting structure for piezoelectric vibrating segment, piezoelectric vibrator, and piezoelectric vibrating gyroscope

(75) Inventors: Eiji Karaki, Ina-shi (JP); Osamu Kawauchi, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/891,124

(22) Filed: Jul. 15, 2004

(30) Foreign Application Priority Data
Jul. 25, 2003 (JP) 2003-201892
Apr. 19, 2004 (JP) 2004-122906

(51) Int. Cl. G01P 9/04

(52) U.S. Cl. 73/504.12; 310/348

(57) ABSTRACT

Aspects of the invention can provide piezoelectric vibrating segment, a supporting structure for the piezoelectric vibrating segment, piezoelectric vibrator, and the piezoelectric vibrating gyroscope capable of maintaining stable excited vibrations and stable sensing vibrations. The piezoelectric vibrating segment can include a base section, a plurality of excited vibration arms and sensing vibration arms radially extending from the base section in a single plane. A plurality of first beams having elasticity extending from the base section and between the vibration arms and, at least, a first supporting section formed on the tips of the beams can be formed. The excited vibration arms and the sensing vibration arms are provided with electrode patterns formed thereon to be connected to and driven by a semiconductor device. The piezoelectric segment is encapsulated by a container composed of a base member and a lid member to form a piezoelectric vibrator and a piezoelectric vibrating gyroscope, and stable excited vibrations and stable sensing vibrations are maintained.

### BACKGROUND OF THE INVENTION

1. Field of Invention

The invention relates to a piezoelectric vibrating segment, a supporting structure for a piezoelectric vibrating segment, a piezoelectric vibrator, and a piezoelectric vibrating gyroscope.

2. Description of Related Art

Piezoelectric vibrating gyroscopes that use piezoelectric vibrating segments or piezoelectric vibrators having the piezoelectric vibrating segments housed in containers have been used as angular velocity sensors for detecting rotational angular velocities in rotational systems. The piezoelectric vibrating gyroscopes are used for car navigation systems or for detecting camera vibration of VTRs or still cameras.

For the piezoelectric vibrating gyroscopes, there are used piezoelectric vibrating segments composed of vibrating arms extending in a single plane and base sections for connecting the vibrating arms. The piezoelectric vibrating gyroscopes drive the piezoelectric vibrating segments to vibrate using drive circuits (excited vibration) and detect sensing vibration caused in accordance with rotational angular velocities using detection circuits to output electric signals. The excited vibration is generated in all or some of a plurality of vibrating arms. When a rotational angular velocity is applied to the piezoelectric vibrating segment, the Coriolis force in a direction perpendicular to the direction of the excited vibration operates on the vibrating arms excitedly vibrating to cause the sensing vibration in the all or some of the plurality of vibrating arms.

As a piezoelectric vibrating segment composed of a plurality of vibrating arms and a base section connecting the vibrating arms, for example, a piezoelectric vibrating segment is known that includes a pair of excited vibration systems extending from the periphery of the base section in directions opposing to each other and a pair of sensing vibration systems extending in directions perpendicular to the extension directions of the excited vibration systems. The excited vibration system has a connecting section connected to the periphery of the base section and an excited vibration arm extending from the connecting section in a traverse direction with respect to the connecting section.

As a conventional supporting structure for the piezoelectric vibrating segment, a structure is adopted in which, with the piezoelectric vibrating segment opposite to a supporting stage, a portion of the base section of the piezoelectric vibrating segment having the smallest vibration amplitude is fixed to a supporting member on the supporting stage. And, the structure is known in which electrodes of the piezoelectric vibration segment are connected to a drive circuit and a detection circuit provided on the supporting stage via metal wires. See, for example, Japanese Unexamined Patent Publication No. 2001-12955.

### SUMMARY OF THE INVENTION

However, according to the supporting structure described above, since the supporting point is only one, the piezoelectric vibrating segment is easy to be tilted when a vibration or an impact is applied from the outside. As a result, a problem arises that the piezoelectric vibrating segment abuts on the supporting stage to make it difficult to keep the stable excited vibration and the stable sensing vibration. Moreover, another problem arises that the excited vibration and the sensing vibration are easy to be suppressed by supporting the piezoelectric vibrating segment.

An aspect of the invention is to provide a piezoelectric vibrating segment, a supporting structure for a piezoelectric vibrating segment, a piezoelectric vibrator, and a piezoelectric vibrating gyroscope capable of keeping a stable excited vibration and a stable sensing vibration even against vibrations or impacts from the outside. Further, an object of the invention is to provide a piezoelectric vibrating segment, a supporting structure for a piezoelectric vibrating segment, a piezoelectric vibrator, and a piezoelectric vibrating gyroscope in which the excited vibration and the sensing vibration are hard to be suppressed if the piezoelectric vibrating segment is supported.

In a piezoelectric vibrating segment according to the invention, a base section, a plurality of vibration arms radially extending from the base section in a single plane, a plurality of first beams having elasticity and extending from the base section and between the vibration arms, and at least a first supporting section formed on a tip portion of the beams are formed. In the above, the vibration arms can include excited vibration arms and sensing vibration arms.

In the piezoelectric vibrating segment according to the invention, since, for example, the first supporting sections are formed on the tips of the respective beams radially extending in four directions from the periphery of the base section of the piezoelectric vibrating segment, the piezoelectric vibrating segment is kept in a balanced and stable posture. Further, since the elastic beams are provided between the base section and the supporting sections, even if vibrations or impacts are applied from the outside, the vibrations or the impacts can be absorbed by the beams to maintain the excited vibrations and the sensing vibrations stable.

Further, it is advantageous that the excited vibrations and the sensing vibrations are hardly be affected by thus supporting the piezoelectric vibrating segment.

In the above structure, the first supporting section, and further, a second supporting section provided on the center of the base section are preferably formed.

The piezoelectric vibrating segment thus structured is equipped with the second supporting section in the center portion of the base section. Therefore, since the periphery portion of the piezoelectric vibrating segment is supported by the first supporting sections and the center portion thereof is supported by the second supporting section, the piezoelectric vibrating segment can be more stably supported. Further, when a strong impact is applied from the outside, it is prevented by the second supporting section that the beams are deformed beyond elastic ranges to cause the piezoelectric vibrating segment be broken.

Further, in the above structure, the first supporting section formed on the tip portion of the beams, a pair of openings symmetrically provided with respect to the center of the base section, a second beam having elasticity and formed between the openings, a second supporting section provided on the center of this beam, and the first beams are preferably formed.

According to the above structure, since the second supporting section also equipped with the elastic beam that absorbs vibrations in the periphery of the base section is provided on the base section in addition to the first sections described above, propagation of the vibrations to the second supporting section can be reduced, and accordingly, negative effects to the excited vibrations or the sensing vibrations derived from providing the second supporting section are also reduced.

Further, the structure of the piezoelectric vibrating segment of the above preferably includes an exciting electrode formed on a surface of the vibration arm for exciting the piezoelectric vibrating segment to vibrate, and conduction electrodes formed on a surface of the first supporting section and a surface of the second supporting section, wherein the exciting electrode is preferably connected to the conduction electrode.

Here, the conduction electrodes denote electrodes for connecting the exciting electrodes with a semiconductor device or an external circuit described below. Thus, the exciting signals for exciting the piezoelectric vibrating segment to vibrate can be sent through the conduction electrodes formed on the surfaces of the first supporting sections and the surface of the second supporting section.

Further, the structure described above preferably comprises the exciting electrode formed on the surface of the vibration arm, and a sensing electrode formed on a different position from the exciting electrode for detecting a sensing vibration generated in the piezoelectric vibrating segment in accordance with the excited vibration and a rotational angular velocity applied from the outside. The sensing electrode and the exciting electrode are preferably connected to different ones of the conduction electrodes.

According to this structure, in addition to the exciting signals, the signals of sensing vibrations can be picked up from the conduction electrodes provided to the first supporting sections or the second supporting section.

Further, it is characterized in that the first supporting section is continuously formed to a frame section formed around the vibration arms.

The piezoelectric vibrating segment described above can be manufactured, for example, from a wafer by photolithography. In this case, the piezoelectric vibrating segment is formed with a situation where the periphery of the piezoelectric vibrating segment is surrounded by the frame section. Since the piezoelectric vibrating segment has the first supporting section integrated with this frame section, the structural strength of the supporting section increases to maintain more stable posture. Further, since the frame sections and the supporting sections are integrated, the piezoelectric vibrating segment is easy to be handled when encapsulated in the container, as described below, to advantageously improve the operating efficiency.

Further, the frame section is preferably formed so as to provide constant gaps with the base section, the vibration arms, and the beams. According to this, since substantially constant circumferential gaps of the piezoelectric vibrating segment with the surrounding frame section are provided, the resist film can be formed in a constant thickness in the resist deposition process of the photolithography process for shaping the piezoelectric vibrating segment by etching. Thus, the shape of each section of the piezoelectric vibrating segment can stably be formed, and, as a result, the excited vibrations and the sensing vibrations can be more stable.

Further, a part of the beam is preferably shaped to have smaller stiffness than the rest.

In this case, as a shape having a smaller stiffness than the rest, the structure in which a part of the beam in between the base section and the supporting sections is thinner than the rest can be adopted.

According to the above, vibrations or impacts caused by the circumferential condition become hard to be propagated from the supporting sections to the base section via the beams, thus the effects of vibrations or the impacts become hard to be applied to the vibration arms, and therefore, the excited vibrations and the sensing vibrations advantageously become hard to be suppressed by supporting the piezoelectric segment. Note that this effect can be enhanced by disposing the low stiffness portion adjacent to the base section.

Furthermore, in the piezoelectric vibrating segment, the exciting electrode and the sensing electrode formed on the vibration arms are preferably connected to the conduction electrodes formed on the frame section.

Note that, hereinafter, the exciting electrode can be referred to as a exciting signal electrode, and the sensing electrode can be referred to as a sensing signal electrode.

As described above, the supporting sections and the frame section can be integrally formed. Therefore, since the exciting electrode and the sensing electrode provided on the vibration arms are connected to the conduction electrode provided on the frame section, the electrode forming process can be simplified and the work efficiency in encapsulating the piezoelectric vibrating segment in a container described below can be enhanced.

Further, a supporting structure for a piezoelectric vibrating segment according to the invention can include a piezoelectric vibrating segment described above, a supporting stage for oppositely mounting the piezoelectric vibrating segment, and fixing members provided between the first supporting sections and the supporting stage and between the second supporting section and the supporting stage for fixing the piezoelectric vibrating segment.

In this case, as a supporting stage, a circuit board with a predetermined electrode pattern formed on a surface hereof can be adopted.

According to the invention, since the piezoelectric vibrating segment is fixed to the supporting stage by, for example, fixing members in five points of the first supporting sections and the second supporting section, the posture thereof can be kept stable even if vibrations or impacts are applied from the outside. Further, since the gaps with the supporting stage can stably be maintained, even if vibrations or impacts are applied from the outside, the piezoelectric vibrating segment can be prevented from abutting on the supporting stage by appropriately setting the height (thickness) of the fixing member, thus enabling to keep the excited vibrations and the sensing vibrations stable.

Further, the fixing members are preferably made of a conductive material. In this case, a conductive adhesive can be adopted as the fixing member. Thus, by using the conductive adhesive, fixing of the piezoelectric vibrating segment to the supporting stage and electrical connection of the exciting electrode or the sensing electrode formed on the piezoelectric vibrating segment with, for example, the electrode patterns formed on the supporting stage via the conduction electrode are easily achieved.

Further, the fixing members described above are preferably made of an elastic material.

According to the structure, since the fixing member having elasticity further absorbs vibrations and impacts from the outside to keep the excited vibrations and the sensing vibrations stable. Further, since the fixing member serves as a buffer member of vibrations leaking to the respective supporting sections, negative effects to the excited vibrations or the sensing vibrations derived from the fixing of the respective supporting sections can further be reduced.

Further, in the supporting structure described above, the fixing member provided between the second supporting section and the supporting stage is preferably thicker than the fixing member provided between the first supporting section and the supporting stage.

In the structure of the invention, it is realized, for example, by forming a portion of the supporting stage for mounting the piezoelectric vibrating segment on which the first supporting section is mounted higher than other portions. According to the structure, the piezoelectric vibrating segment is supported by the first supporting sections via a thin fixing member and has a thicker fixing member between the second supporting section and the supporting stage. The second supporting section is provided on the base section as described above. Accordingly, the fixing member of the second supporting section thicker than those of the first supporting sections and is easier to be deformed to reduce negative effects derived from fixing of the second supporting section.

Further, the exemplary supporting structure for a piezoelectric vibrating segment according to the invention can include a piezoelectric vibrating segment having the first supporting sections formed integrally with the frame section formed surrounding the vibration arms, a base member to which the piezoelectric vibrating segment is fixed wherein the frame section formed on the piezoelectric vibrating segment is fixed to the base member. Note that the base member functions as the supporting stage, and denotes a part of a container for encapsulating the piezoelectric vibrating segment.

According to the exemplary structure, since the frame section including support sections is fixed to and supported by the base member using, for example, the fixing member described above, the piezoelectric vibration segment can more stably be supported. Further, since the piezoelectric vibrating segment can directly be fixed to the base member without using the supporting stage described above, the structure can be simplified and miniaturized.

Further, in the supporting structure for a piezoelectric vibrating segment, a periphery portion of the frame section of the piezoelectric vibrating segment is preferably fixed to a periphery portion of the base member. Thus, since materials of the fixing member is not limited to the conductive adhesive, and the piezoelectric vibrating segment is directly fixed to the base member, fixing strength can be increased to reduce vibration leakage in the piezoelectric vibrator.

A piezoelectric vibrator according to the invention can include, a piezoelectric vibrating segment described above, a base member to which the piezoelectric vibrating segment is fixed, and a lid member for housing and hermetically sealing the piezoelectric vibrating segment in cooperation with the base member. Thus, since the piezoelectric vibrating segment is hermetically sealed by the base member and the lid member, the piezoelectric vibrator can be provided that keeps the excited vibrations and the sensing vibrations stable even if vibrations or impacts are applied from the outside. Further, since the inside of the piezoelectric vibrator according to the present invention is kept, for example, vacuum to avoid effects of environmental condition such as moisture or an impact, a predetermined performance can be maintained for a long period of time.

An exemplary piezoelectric vibrating gyroscope according to the invention can include a piezoelectric vibrating segment described above, a drive circuit for exciting the piezoelectric vibrating segment to vibrate, and a detection circuit for detecting the sensing vibration generated in the piezoelectric vibrating segment in response to application of rotational angular velocity from the outside to the piezoelectric vibrating segment.

According to the invention, since the piezoelectric vibrating segment comprises the elastic beams, the piezoelectric vibrating segment can be provided in which the excited vibrations and the sensing vibration are kept stable, and the excited vibrations and the sensing vibrations are hard to be affected by supporting the piezoelectric vibrating segment if vibrations or impacts are applied from the outside.

### BRIEF DESCRIPTION OF THE DRAWINGS

This invention will be described with reference to the accompanying drawings, wherein like numerals reference like elements, and wherein:

FIG. 1 is a plan view showing a piezoelectric vibrating segment according to a first embodiment of the invention;

FIG. 2 is a plan view showing electrode patterns on one principal surface of the piezoelectric vibrating segment according to the first embodiment of the invention;

FIG. 3 is a plan view showing electrode patterns on the other principal surface of the piezoelectric vibrating segment according to the first embodiment of the invention;

FIG. 4 is a cross-sectional view showing a supporting structure for the piezoelectric vibrating segment according to the first embodiment of the invention;

FIG. 5 is a cross-sectional view showing the supporting structure for the piezoelectric vibrating segment according to the first embodiment of the invention;

FIG. 6 is a plan view showing electrode patterns of a substrate according to the first embodiment of the invention;

FIG. 7 is a plan view showing electrode patterns of the substrate according to the first embodiment of the invention;

FIG. 8 is a schematic view showing an excited vibration of the piezoelectric vibrating segment according to the first embodiment of the invention;

FIG. 9 is a schematic view showing a sensing vibration of the piezoelectric vibrating segment according to the first embodiment of the invention;

FIG. 10 is a schematic view showing a vibration form of the piezoelectric vibrating segment according to the first embodiment of the invention;

FIG. 11 is a schematic view showing a vibration form of the piezoelectric vibrating segment according to the first embodiment of the invention;

FIG. 12 is a cross-sectional view showing a piezoelectric vibrating gyroscope according to the first embodiment of the invention;

FIG. 13 is a plan view showing one principal surface of the piezoelectric vibrating segment according to a second embodiment of the invention;

FIG. 14 is a plan view showing the other principal surface of the piezoelectric vibrating segment according to the second embodiment of the invention;

FIG. 15 is a cross-sectional view showing a supporting structure for the piezoelectric vibrating segment according to the second embodiment of the invention;

FIG. 16 is a schematic view showing a vibration form of the piezoelectric vibrating segment according to the second embodiment of the invention;

FIG. 17 is a schematic view showing a vibration form of the piezoelectric vibrating segment according to the second embodiment of the invention;

FIG. 18 is a plan view showing a structure of a piezoelectric vibrator according to a third embodiment of the invention;

FIG. 19 is a cross-sectional view showing the structure of the piezoelectric vibrator according to the third embodiment of the invention;

FIG. 20 is a plan view showing a piezoelectric vibrating segment according to a fourth embodiment of the invention;

FIG. 21 is a plan view showing a modified example of the piezoelectric vibrating segment according to the fourth embodiment of the invention;

FIG. 22 is a plan view showing another modified example of the piezoelectric vibrating segment according to the fourth embodiment of the invention;

FIG. 23 is a plan view showing a piezoelectric vibrating segment according to a fifth embodiment of the invention;

FIG. 24 is a plan view showing a modified example of the piezoelectric vibrating segment according to the fifth embodiment of the invention;

FIG. 25 is a plan view showing another modified example of the piezoelectric vibrating segment according to the fifth embodiment of the invention;

FIG. 26(a) is a plan view showing another modified example of the piezoelectric vibrating segment according to the fifth embodiment of the invention; FIGS. 26(b) and 26(c) are cross-sectional views showing another modified example of the piezoelectric vibrating segment according to the fifth embodiment of the invention;

FIG. 27 is a plan view showing electrode patterns on the front surface of the piezoelectric vibrating segment according to the fifth embodiment of the invention;

FIG. 28 is a plan view showing electrode patterns on the reverse surface of the piezoelectric vibrating segment according to the fifth embodiment of the invention;

FIG. 29 is a cross-sectional view showing a piezoelectric vibrating gyroscope according to the fifth embodiment of the invention;

FIG. 30 is a partial cross-sectional view showing a piezoelectric vibrating gyroscope according to a sixth embodiment of the invention; and

FIG. 31 is a partial cross-sectional view showing a piezoelectric vibrator according to a seventh embodiment of the invention;

### DETAILED DESCRIPTION OF PREFERRED EMBODIMENTS

An embodiment of the invention is hereinafter described referring to the accompanying drawings.

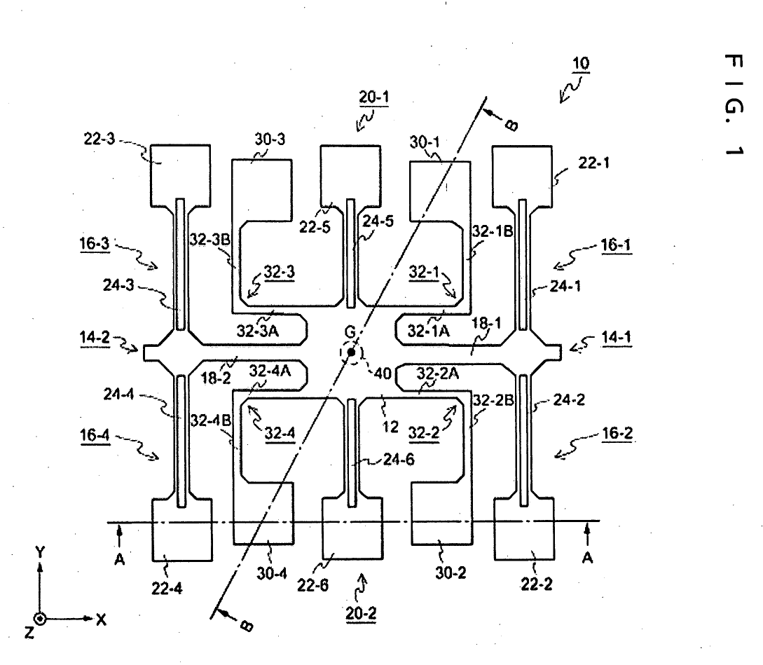

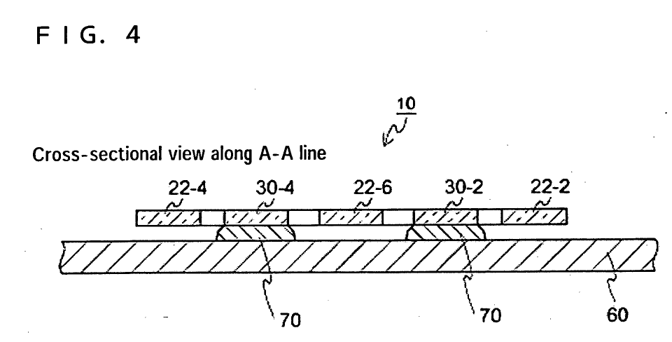

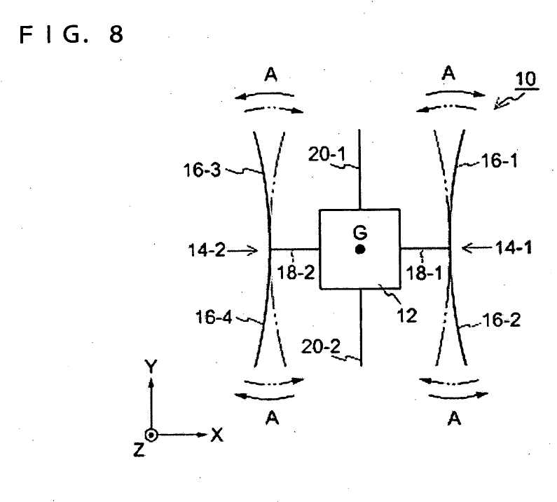

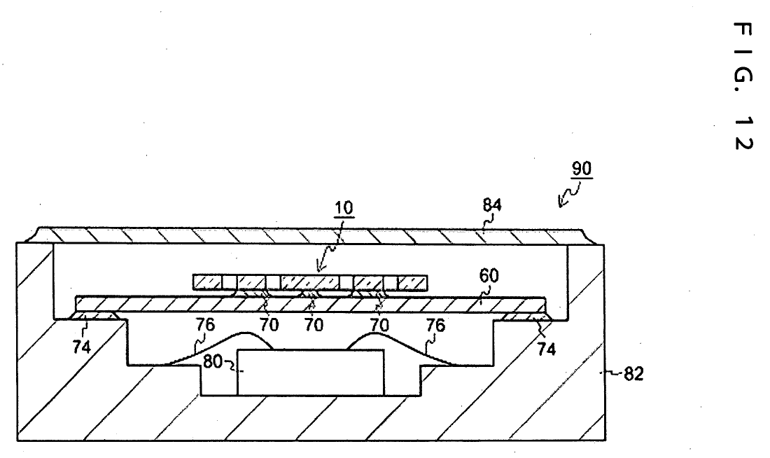

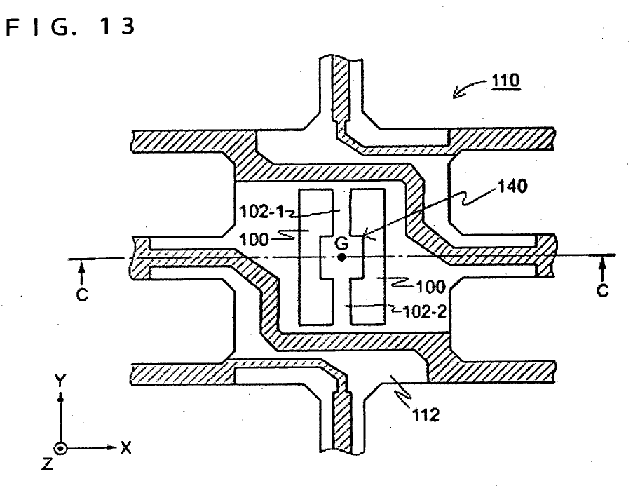

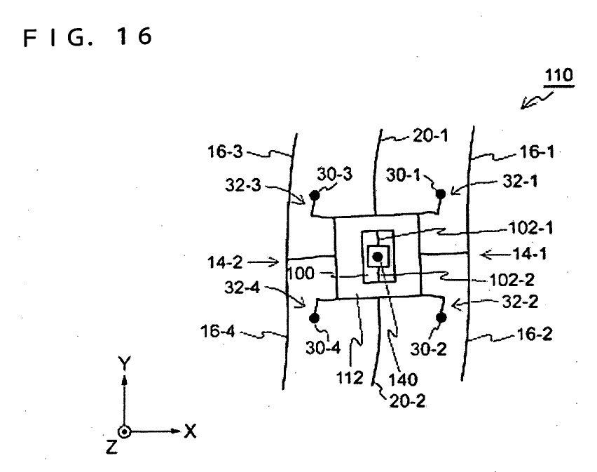

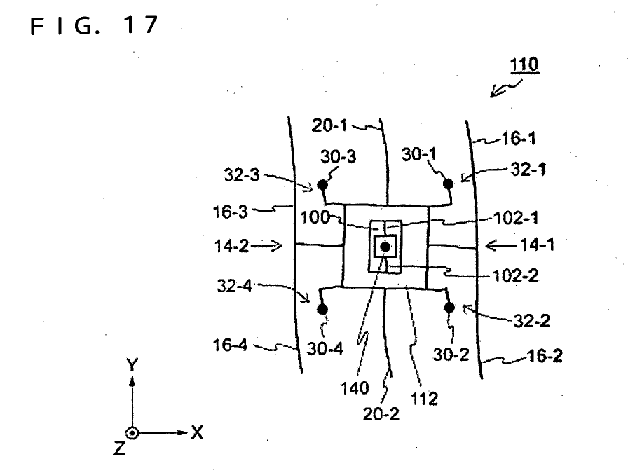

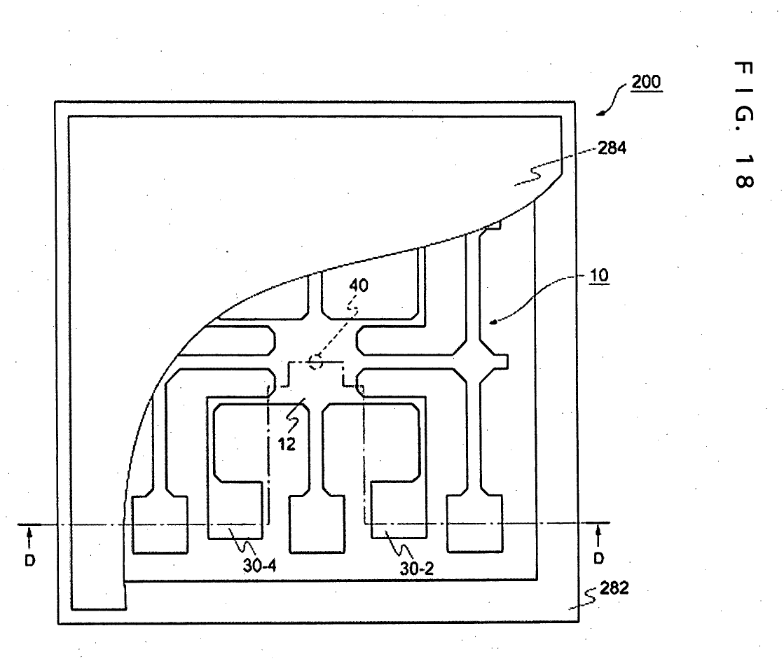

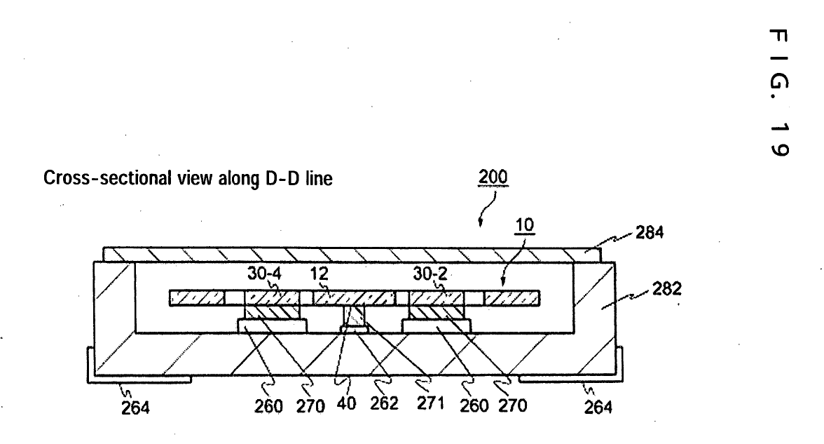

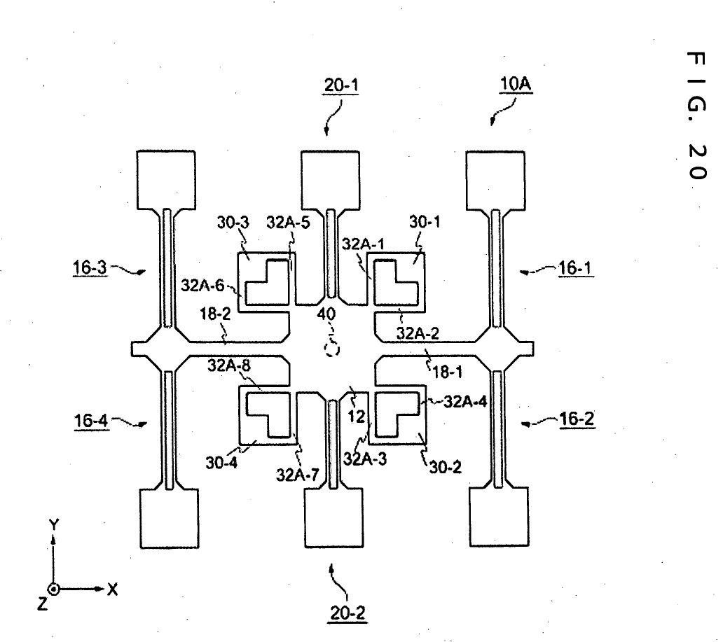

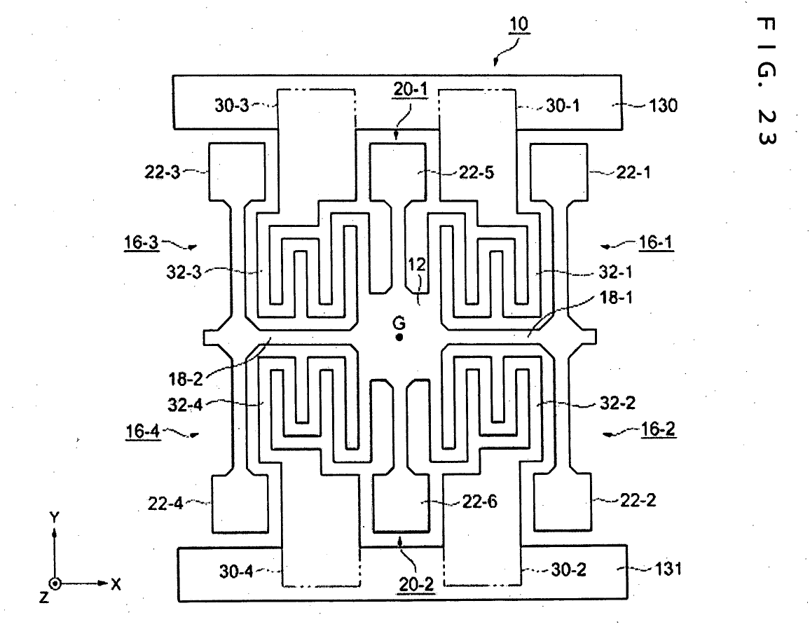

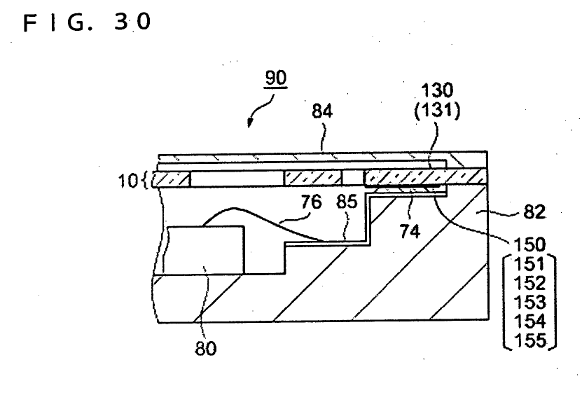

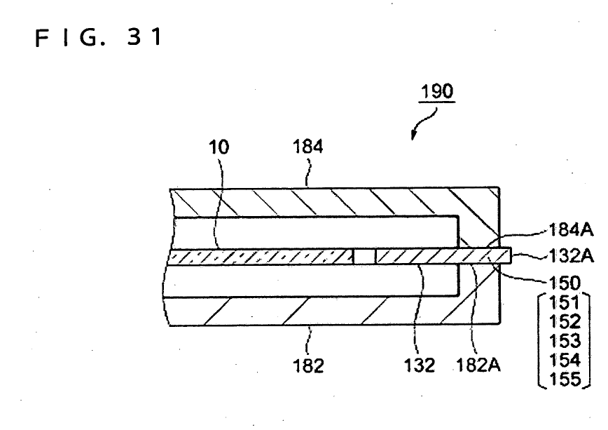

FIGS. 1 through 3 show a piezoelectric vibrating segment according to a first exemplary embodiment of the invention, FIGS. 4 through 7 show a supporting structure for a piezoelectric vibrating segment, FIGS. 8 through 11 show an operation of the piezoelectric vibrating segment, FIG. 12 shows a piezoelectric vibrating gyroscope according to the first embodiment, FIGS. 13 through 15 show a piezoelectric vibrating segment and a supporting structure therefor according to a second embodiment of the present invention, FIGS. 16 and 17 show an operation of the piezoelectric vibrating segment, FIGS. 18 and 19 show a piezoelectric vibrator according to a third embodiment, and FIGS. 20 through 22 show a piezoelectric vibrating segment according to a fourth embodiment. Furthermore, FIGS. 23 through 29 show a piezoelectric vibrating segment and a piezoelectric vibrating gyroscope according to a fifth embodiment of the present invention, FIG. 30 shows a piezoelectric vibrating gyroscope according to a sixth embodiment, and FIG. 31 shows a piezoelectric vibrator according to a seventh embodiment.

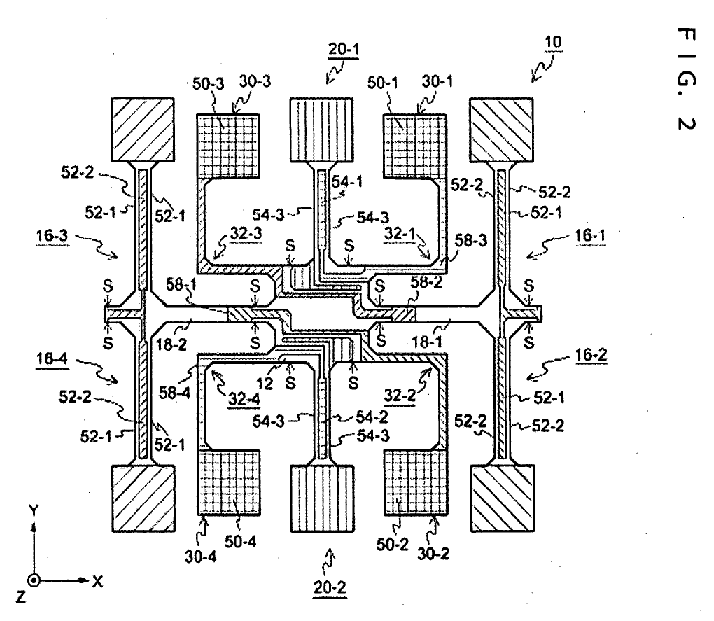

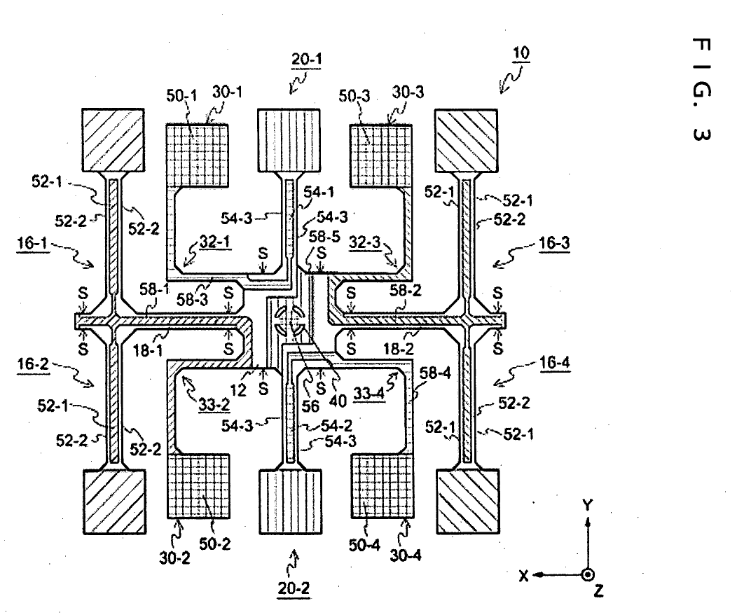

FIGS. 1 through 3 show a shape of the piezoelectric vibrating segment according to the first exemplary embodiment of the invention. FIG. 1 is a plan view showing the shape of the piezoelectric vibrating segment according to the first embodiment. And, FIGS. 2 and 3 are plan views showing a electrode pattern formed on the surface of the piezoelectric vibrating segment. In FIG. 1, the piezoelectric vibrating segment 10 is formed in the X-Y plane. In the first embodiment, the piezoelectric vibrating segment is made of quartz, a Z-cut quartz substrate that is cut so that, defining the X axis called an electric axis, the Y axis called a mechanical axis, are the Z axis called optical axis, the X axis and the Y axis are set in the plane direction.

The piezoelectric vibrating segment 10 is formed of the quartz substrate of a predetermined thickness. The planar figure of the piezoelectric vibrating segment 10 is spreading in the X-Y plane along the crystal axis of the quartz and is 180 degree symmetrical about the center point G. The center point G is the center of mass of the piezoelectric vibrating segment 10. Further, although not shown in FIG. 1, a predetermined electrode as described below is formed on the surface of the piezoelectric vibrating segment 10 (See FIGS. 2 and 3.).

The piezoelectric vibrating segment 10 has a base section 12 having edge surfaces parallel to the X axis direction or the Y axis direction respectively, a pair of excited vibration systems 14-1, 14-2 each extending in a direction parallel to the X axis from the center of respective one of the pair of side surfaces of the base section 12 parallel to the Y axis, and a pair of sensing vibration arms 20-1, 20-2 each extending in a direction parallel to the Y axis from the center of respective one of the pair of side surfaces of the base section 12 parallel to the X axis. The excited vibration system 14-1 is composed of a connecting arm 18-1 connecting to the side surface of the base section 12 and a pair of excited vibration arms 16-1, 16-2 extending from the connecting arm 18-1 in a direction traversing the connecting arm 18-1. Similarly, the excited vibration arm 14-2 in the opposite side of the center point G is composed of a connecting arm 18-2 and a pair of excited vibration arms 16-3, 16-4.

On the tip of the excited vibration arms 16-1, 16-2, 16-3, and 16-4, there are respectively formed rectangular weight sections 22-1, 22-2, 22-3, and 22-4 that are wider than the other portions thereof. Further, on the tip of the sensing vibration arms 20-1 and 20-2, there are respectively formed rectangular weight sections 22-5 and 22-6 that are wider than the other portions thereof.

In the center in the width direction of the excited vibration arms 16-1, 16-2, 16-3, and 16-4, there are formed concave grooves 24-1, 24-2, 24-3, and 24-4 in the thickness direction. In a similar manner, grooves 24-5 and 24-6 are respectively formed on the sensing vibration arms 20-1 and 20-2.

The width and length of each section of the beams 32-1, 32-2, 32-3, and 32-4 described above are designed so as to provide appropriate elasticity in both the X axis and the Y axis directions.

The weight sections 22-1 through 22-6 and the grooves 24-1 through 24-6 are elements for forming the piezoelectric vibrating segment in a smaller size but not particularly limiting the scope of the present invention.

In the excited vibration arms 16-1, 16-2, 16-3, and 16-4, the width and the length of the excited vibration arms 16-1 through 16-4, the size of the weight sections 22-1 through 22-4, the size of the grooves 24-1 through 24-4 and so forth are designed so as to generate the excited vibration of a predetermined frequency. Similarly, in the sensing vibration arms 20-1 and 20-2 and the connecting arms 18-1 and 18-2, the width and the length of the sensing vibration arms 20-1 and 20-2, the size of the weight sections 22-5 and 22-6, the size of the grooves 24-5 and 24-6 and so forth are designed so as to generate a predetermined sensing vibration.

Further, in the piezoelectric vibrating segment 10 a second supporting section 40 is formed on the center of one surface of the base section 12, the second supporting section 40 including the center point G. The second supporting section 40 is a small region around the center of the base section 12 in the surface that faces a supporting stage when the piezoelectric vibrating segment 10 is mounted on a substrate 60 (See FIG. 12.) described below so as to face the substrate 60. The second supporting section 40 is substantially a circle having the area of a forth through a thousandth of the area of the base section 12. It is preferably set to a sixteenth through hundredth thereof.

In the tips of the beams 32-1, 32-2, 32-3, and 32-4 described above, there are respectively formed first supporting sections 30-1, 30-2, 30-3, and 30-4 each having a substantially rectangular shape. The piezoelectric vibrating segment 10 according to the exemplary embodiment 1 is formed having four of the first supporting sections 30-1 through 30-4 described above and the second supporting section 40 as five supporting sections, and is mounted on the substrate 60 described below.

Furthermore, the beams 32-1 through 32-4 described above are formed to have shapes elastic with respect to the vibration of the periphery of the base section 12 to absorb vibrations or impacts from the outside when the piezoelectric vibrating segment 10 is mounted on the substrate 60.

Note that since the piezoelectric vibrating segment 10 according to the exemplary embodiment can be formed as a single piece by etching using a photolithography technology, a plurality of piezoelectric vibrating segments can be formed simultaneously.

Hereinafter, the electrode pattern of the piezoelectric vibrating segment 10 according to the exemplary embodiment is described referring to FIGS. 2 and 3. FIG. 2 is a plan view showing an electrode pattern in one principal surface of the piezoelectric vibrating segment according to the present embodiment 1. And, FIG. 3 is a plan view showing an electrode pattern in the other principal surface thereof. Here, the principal surface denotes a surface of the piezoelectric vibrating segment 10 parallel to the X-Y plane, the surface shown in FIG. 3 facing the substrate 60 as a supporting stage in a supporting structure for the piezoelectric vibrating segment 10 as described below (See FIG. 12.). In these drawings the elements shown in FIG. 1 are denoted with the same reference numerals, and descriptions therefor are omitted here. In FIGS. 2 and 3, checked portions denote conduction electrodes, and for ease of discriminating plural types of electrodes they are denoted with hatching, vertical stripes, and horizontal stripes. Although not shown in the drawings, electrodes are formed also on surfaces parallel to the Z axis (herein after referred to as side surfaces). Note that in the side surfaces pointed by the arrow S no electrodes are formed to have electrical insulation-with-adjacent electrodes.

In both of the principal surfaces of the exited vibration arms 16-1 and 16-2 first exciting electrodes 52-1 elongated along the length direction of the arms are formed in the center of the arm width. In the both side surfaces thereof, second exciting electrodes 52-2 are formed. In contrast, in both of the principal surfaces of the excited vibration arms 16-3 and 16-4, the second exciting electrodes 52-2 elongated along the length direction of the arms are formed in the center of the arm width. And, in the both side surfaces thereof, the first exciting electrodes 52-1 are formed.

The exciting electrodes 52-1 are connected by connecting electrodes 58-1 formed on the connecting arms 18-1, 18-2 described above and the base section 12, and further connected to conduction electrodes 50-2 formed on the surfaces of the first supporting section 30-2. Similarly, the second exciting electrodes 52-2 are connected to conduction electrodes 50-3 formed on the surfaces of the first supporting section 30-3 via the connecting electrode 58-2.

In both of the principal surfaces of the sensing vibration arms 20-1, first sensing electrodes 54-1 elongated along the length direction of the arms are formed in the center of the arm width. Similarly, in both of the principal surfaces of the sensing vibration arms 20-2, second sensing electrodes 54-2 are formed. And, third sensing electrodes 54-3 are formed on both side surfaces of the sensing vibration arms 20-1 and 20-2.

The first sensing electrodes 54-1 can be connected to conduction electrodes 50-1 formed on both surfaces of the first supporting section 30-1 via connecting electrodes 58-3 formed on the base section 12 and the beam 32-1. Similarly, the second sensing electrodes 54-2 are electrically connected to conduction electrodes 50-4 formed on the surfaces of the first supporting section 30-4 via connecting electrodes 58-4. And, the third sensing electrodes 54-3 are connected by connecting electrodes 58-5 formed on the base section 12 to a conduction electrode 56 formed on the second supporting section 40.

As described above, in the piezoelectric vibrating segment 10, by applying exciting signals between the conduction electrodes 50-2 formed on the first supporting section 30-2 and the conduction electrodes 50-3 formed on the first supporting section 30-3, an electric field can be generated between the first exciting electrodes 52-1 and the second exciting electrodes 52-2 to make the excited vibration arms 16-1, 16-2, 16-3, and 16-4 excitedly vibrate.

Further, a sensing vibration generated in the sensing vibration arm 20-1 appears as an electric charge between the first sensing electrodes 54-1 and the third sensing electrodes 54-3 that can be obtained as an electric signal from the conduction electrodes 50-1 formed on the first supporting section 30-1 and the conduction electrode 56 formed on the second supporting section 40. Likewise, a sensing vibration generated in the sensing vibration arm 20-2 can be obtained as an electric signal from the conduction electrodes 50-4 formed on the first supporting section 30-4 and the conduction electrode 56 formed on the second supporting section 40.

Note that the electrode pattern of the piezoelectric vibrating segment of the present embodiment 1 as described above can be provided by forming a metal film on a surface of the piezoelectric vibrating segment 10 so shaped followed by etching using a photolithography technology.

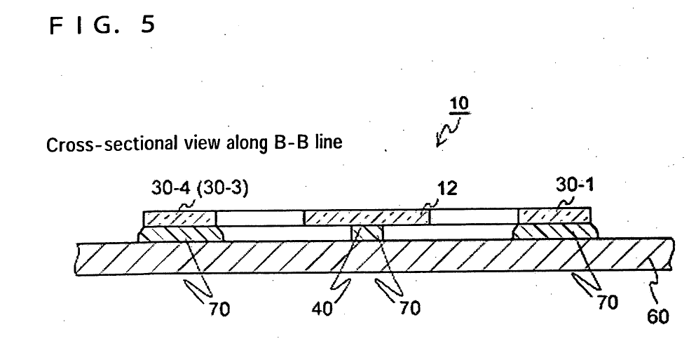

Following the above, the supporting structure for the piezoelectric vibrating segment 10 according to the exemplary embodiment is described referring to FIGS. 4 and 5. FIG. 4 shows a cross-sectional view of the supporting structure at a position corresponding to the A-A line of the piezoelectric vibrating segment 10 shown in FIG. 1. FIG. 5 in like wise shows a cross-sectional view of the supporting structure at a position corresponding to the B-B line in FIG. 1. In these drawings, the same elements as those shown in FIG. 1 are denoted with the same reference numerals, and descriptions therefor are omitted. In the embodiment, conductive adhesive 70 is used as a fixing member, and the substrate 60 made of a ceramic material or the like is used as the supporting stage for mounting the piezoelectric vibrating segment 10.

In FIGS. 4 and 5, the piezoelectric vibrating segment 10 is oppositely mounted on the substrate 60. And, the piezoelectric vibrating segment 10 is fixed by adhering the first supporting sections 30-1, 30-2, 30-3, and 30-4 to the substrate 60 with the conductive adhesive 70. Since the conductive adhesive 70 has a certain thickness, the piezoelectric vibrating segment 10 is mounted on the substrate 60 with a gap to prevent the excited vibration systems 14-1 and 14-2 and the sensing vibration arms 20-1 and 20-2 from abutting on the substrate 60.

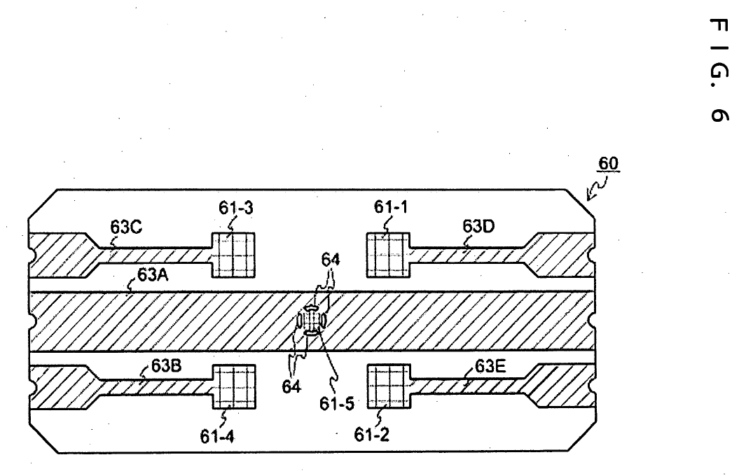

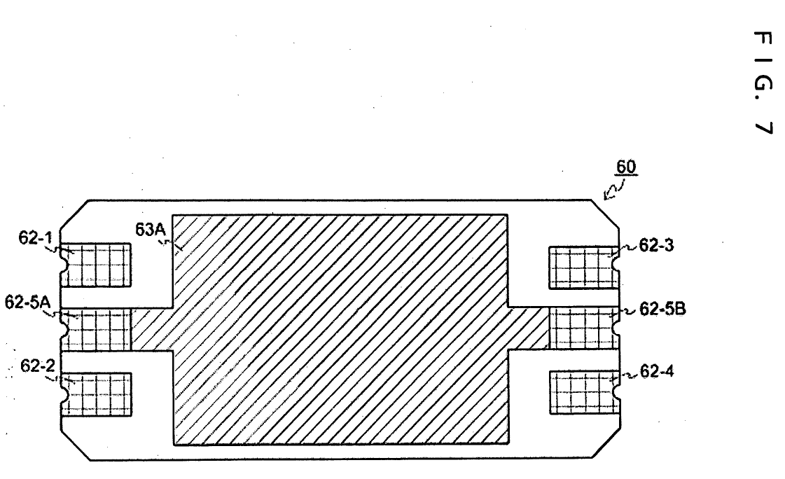

In the substrate 60, there are formed electrode patterns shown in FIGS. 6 and 7 as described below to respectively provide electrical connections with the conduction electrode 50-1, 50-2, 50-3, 50-4, and 56 via the conductive adhesive 70. In this case, the conductive adhesive 70 is preferably an elastic material. As an example of such an elastic conductive adhesive, conductive adhesive using the silicone resin as the base material is known.

FIGS. 6 and 7 show the electrode patterns of the substrate 60. FIG. 6 shows a diagram of the electrode patterns on the surface on which the piezoelectric vibrating segment 10 is mounted, and FIG. 7 shows a diagram of the electrode patterns on the opposite surface. In FIGS. 6 and 7, hatched portions denote the electrode patterns, and checked portions denote electrode lands for providing electrical connections with external components.

In FIG. 6, vibrating segment mounting electrode lands 61-1, 61-2, 61-3, and 61-4 are formed on substantially the center portion of the substrate 60 on which the first supporting sections 30-1, 30-2, 30-3, and 30-4 are fixedly adhered respectively. Further, on the vibration segment mounting electrode land 61-5 surrounded by a plurality of electrode slits 64, the second supporting section 40 of the piezoelectric vibrating segment 10 is fixedly adhered. The electrode slits 64 are provided for preventing the conductive adhesive 70 from flowing out of the vibrating segment mounting electrode land to the periphery thereof.

In FIG. 7, external connection electrode lands 62-1, 62-2, 62-3, 62-4, 62-5A, and 62-5B are formed on both shorter sides of a rectangle like shape of the substrate 60. The external connection electrode lands 62-1, 62-2, 62-3, 62-4, 62-5A, and 62-5B are respectively connected to the vibrating segment mounting electrode lands 61-1, 61-2, 61-3, 61-4, and 61-5 via electrode patterns 63D, 63E, 63C, 63B, and 63A shown in FIG. 6.

As described above, in the supporting structure for the piezoelectric vibrating segment 10 of the exemplary embodiment 1, the conductive adhesive 70 is used as the fixing member for supporting and fixing the five points including the four of the first supporting sections 30-1, 30-2, 30-3, and 30-4 and the second supporting section 40 provided on the piezoelectric vibrating segment 10. Further, the structure also providing electrical connection with the vibrating segment mounting electrode lands 61-1, 61-2, 61-3, 61-4, and 61-5 formed on the substrate 60.

Hereinafter, an operation of the piezoelectric vibrating segment 10 supported by the supporting structure according to the present embodiment 1. the piezoelectric vibrating segment 10 absorbs vibrations generated in the periphery of the base section 12 by distortion of the beams 32-1, 32-2, 32-3, and 32-4. Thus, if portions (specifically the first supporting sections 30-1, 30-2, 30-3, and 30-4) other than the center portion of the base section 12 where large vibrations are not generated are supported to be fixed, the excited vibrations and the sensing vibrations are hard to be suppressed.

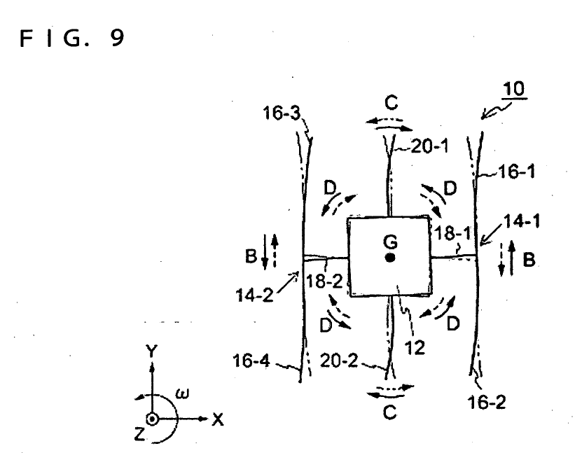

FIGS. 8 and 9 are plan views for schematically describing the operation of the piezoelectric vibrating segment 10 according to the present embodiment 1. In FIGS. 8 and 9, each vibration arm is simply illustrated by a line in order to express the vibration form easily to understand. Further, the beams 32-1, 32-2, 32-3, and 32-4 are omitted. The same elements as those in FIG. 1 are denoted with the same reference numerals, and descriptions therefor are omitted.

FIG. 8 is a drawing for explaining the excited vibration. In FIG. 8, the excited vibration is a bending vibration of the excited vibration arms 16-1, 16-2, 16-3, and 16-4 denoted by the arrows A in which the arms repeat taking one vibration shape illustrated by a solid line and then taking the other vibration shape illustrated by a broken line at a predetermined frequency. In this case, since a pair of the excited vibration arms 16-1, 16-2 and a pair of the excited vibration arms 16-3, 16-4 vibrate symmetrically with respect to an axis that is parallel to the Y axis and passes over the center point G, the base section 12, the connecting arms 18-1, 18-2, and sensing vibration arms 20-1, 20-2 hardly vibrate.

FIG. 9 is a drawing for explaining the sensing vibration. According to FIG. 9, in the sensing vibration, the vibration arms repeat taking one vibration shape illustrated by a solid line and then taking the other vibration shape illustrated by a broken line at the frequency of the excited vibration. The sensing vibration is generated by the Coriolis force of the direction denoted by the arrow 13 acting on the excited vibration systems 14-1 and 14-2 when a rotational angular velocity ω around the Z axis is applied to the piezoelectric vibrating segment 10 while the piezoelectric vibrating segment 10 is performing the excited vibration as shown in FIG. 8.

According to the above, the excited vibration systems 14-1 and 14-2 vibrate as denoted with the arrow B. The vibration denoted with the arrow B is a vibration in a rotational direction around the center point G. At the same time, the sensing vibration arms 20-1 and 20-2 vibrate, as denoted with the arrow C, in the opposite rotational direction to the arrow B in response to the vibration of arrow B.

In this case, the periphery of the base section 12 vibrates, as denoted with the arrow D, in a rotational direction around the center point G. This is because the sensing vibration is not a balancing vibration of the sensing vibration arms 20-1, 20-2 with only the excited vibration systems 14-1, 14-2 but is rather a balancing vibration including the base section 12.

Although the vibration amplitude of the periphery of the base section 12 as denoted with the arrow D is small in comparison with the vibration amplitude of excited vibration systems 14-1, 14-2 as denoted with the arrow B or the vibration amplitude of the sensing vibration arms 20-1, 20-2 as denoted with the arrow C, if, for example, the periphery portion of the base section 12 is fixedly adhered to the substrate 60 by the conductive adhesive or the like, the vibration amplitude of the periphery of the base section 12 is suppressed and accordingly the whole sensing vibration is suppressed.

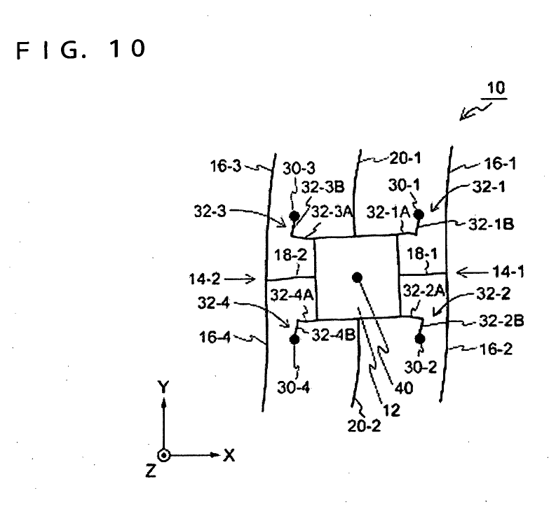

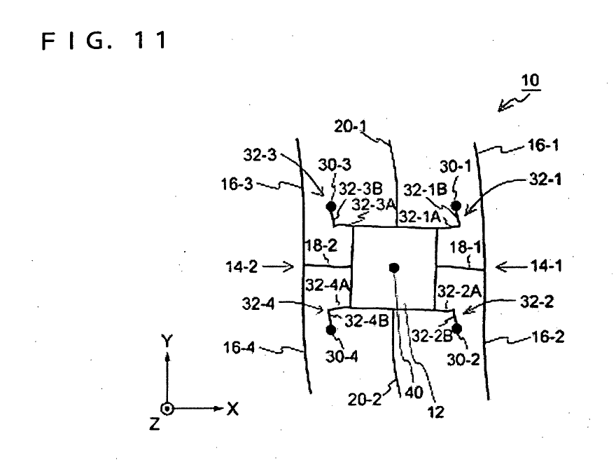

FIGS. 10 and 11 are schematic plan views for explaining the vibration form of the sensing vibrations according to the present embodiment 1 in further detail. In FIGS. 10 and 11, the beams 32-1, 32-2, 32-3, 32-4, the first supporting sections 30-1, 30-2, 30-3, and 30-4 are added to the drawing shown in FIG. 9. Each of the vibration arms and the beams is expressed by a line, and each of the supporting sections is expressed by a dot. The vibration form shown in FIG. 10 corresponds to the vibration form expressed by the solid lines of FIG. 9, and the vibration form shown in FIG. 11 corresponds to the vibration form expressed by the broken lines of FIG. 9. The same elements as those in FIG. 1 are denoted with the same reference numerals, and descriptions therefor are omitted.

In FIGS. 10 and 11, since the first supporting sections 30-1, 30-2, 30-3, 30-4, and the second supporting section 40 are fixedly adhered to the substrate 60, the positional relationships thereof are maintained in each of the vibration forms. Regarding the sensing vibration, the periphery of the base section 12 vibrates in the rotational direction around the center point G as explained referring to FIG. 9. In this case, the beams 32-1, 32-2, 32-3, and 32-4 can be bent in response to movement of the periphery of the base section 12.

Since the beams 32-1, 32-2, 32-3, and 32-4 include beams 32-1B, 32-2B, 32-3B, and 32-4B that are parallel to the Y axis and easy to be bent in the X axis direction and beams 32-1A, 32-2A, 32-3A, and 32-4A that are parallel to the X axis and easy to be bent in the Y axis direction, the beams can deal with the vibration of the base section 12 in the rotational direction of the periphery.

Hereinafter, a structure of a piezoelectric vibrating gyroscope 90 using the piezoelectric vibrating segment 10 is described with reference to FIG. 12. FIG. 12 is a cross-sectional view showing the structure of the piezoelectric vibrating gyroscope 90 according to the first exemplary embodiment. The same elements as those in FIGS. 4 and 5 are denoted with the same reference numerals, and descriptions therefor are omitted. In FIG. 12, the piezoelectric vibrating gyroscope 90 comprises the piezoelectric vibrating segment 10 and a semiconductor device 80 encapsulated in a container formed of a base member 82 and a lid member 84. The container formed of the base member 82 and the lid member 84 provides hermetic sealing to maintain inside thereof vacuum.

The base member 82 is formed of laminated ceramics, and is provided with necessary electrode wiring. A metal film is formed on the upper surface of the periphery of the base member 82, and the lid member 84 made of metal is welded on the upper surface of the base member 82.

The semiconductor device 80 can include a drive circuit for exciting the piezoelectric vibrating segment 10 to vibrate and a detection circuit for detecting the sensing vibration generated at the piezoelectric vibrating segment 10 when a rotational angular velocity is externally applied to the piezoelectric vibrating segment 10 to output an electric signal in accordance the rotational angular velocity.

The semiconductor device 80 is fixed to a surface of the lowest step of the base member 82 and is connected to the electrode wiring (not shown in the drawings) formed on the base member 82 via gold wires 76. The piezoelectric vibrating segment 10 is fixedly adhered to the substrate 60 by the conductive adhesive 70, and the substrate 60 is fixedly adhered to the medium step of the base member 82 by a conductive adhesive 74.

According to the structure described above, the excitation electrodes and the sensing electrodes formed on the piezoelectric vibrating segment 10 are connected to the semiconductor device 80 via the electrode patterns formed on the substrate 60, the electrode wiring provided on the base member 82, and the gold wires 76. Thus, the piezoelectric vibrating segment 10 is excited to vibrate by the drive circuit of the semiconductor device 80 and output a signal caused by the sensing vibration corresponding to the rotational angular velocity to the detection circuit of the semiconductor device 80. And then the semiconductor device 80 outputs the electric signal corresponding to the rotational angular velocity.

Therefore, according to the first exemplary embodiment as described above, since the piezoelectric vibrating segment 10 is fixed to the substrate 60 by the five supporting sections including the first supporting sections 30-1, 30-2, 30-3, and 30-4 provided on the tips of the beams 32-1 through 32-4 extending radially from the base section 12 and the second supporting section 40 provided on the center portion of the base section 12, the piezoelectric vibrating segment can be supported on the substrate 60 with a stable posture.

Furthermore, since the beams 32-1 through 32-4 are formed to have shapes elastic with respect to the vibration of the periphery of the base section 12, negative effects to the excited vibrations or the sensing vibrations derived from fixing the piezoelectric vibrating segment 10 to the substrate 60 can be reduced, and further, negative effects to a drive signal or the sensing vibrations derived from externally applied vibrations or impacts can also be reduced by absorbing them by the beams 32-1 through 32-4.

Still further, since the exciting electrodes 52-1, 52-2 and the sensing electrodes 54-1 through 54-3 formed on the surface of the respective vibration arms of the piezoelectric vibrating segment 10 are connected to the conduction electrodes 50-1 through 50-4, and 56 formed on the surface of the respective supporting sections, predetermined electrical connections can be provided by the conduction electrodes 50-1 through 50-4, and 56 simplifying the structures of the electrode patterns.

Further, according to the supporting structure for the piezoelectric vibrating segment 10 of the first exemplary embodiment, since the piezoelectric vibrating segment 10 is supported by the five supporting sections, the stable posture thereof with respect to the substrate 60 can be maintained if external vibrations or impacts are applied thereto. Further, since the gap between the piezoelectric vibrating segment 10 and substrate 60 can be stably maintained to prevent the excited vibration arms 16-1 through 16-4 and the sensing vibration arms 20-1, 20-2 from abutting on the substrate even if vibrations or impacts are externally applied, the excited vibrations and the sensing vibrations can be stably maintained.

Further, since the conductive adhesive 70 as the fixing member, the electrical connection can be provided in a reduced space without using other electrical connection means such as a metal wire. Still further, since the conductive adhesive 70 has elasticity, vibrations and impacts applied from the outside can be absorbed to maintain the excited vibrations and the sensing vibrations more stably. Further, since the fixing member serves as a buffer member of vibrations leaking to the respective supporting sections, negative effects to the excited vibrations or the sensing vibrations derived from the fixing of the respective supporting sections can further be reduced.

Since the piezoelectric vibrating gyroscope 90 according to the first exemplary embodiment is composed of the piezoelectric vibrating segment 10 maintained in a stable posture or the supporting structure for the piezoelectric vibrating segment, the piezoelectric vibrating gyroscope 90 can stably operate without any disturbance in the vibrations even if external vibrations or impacts are applied. Further, since the vacuum condition is maintained in the container of the piezoelectric vibrator to avoid any effects from the environmental condition such as moisture or an impact, a predetermined performance can be maintained for a long period of time.

Hereinafter, a configuration of a second exemplary embodiment according to the invention is described referring to FIGS. 13 through 17. The second embodiment is characterized in a structure of a second supporting section 140 provided on a base section 112 of a piezoelectric vibrating segment 110 in comparison with the configuration of the first embodiment.

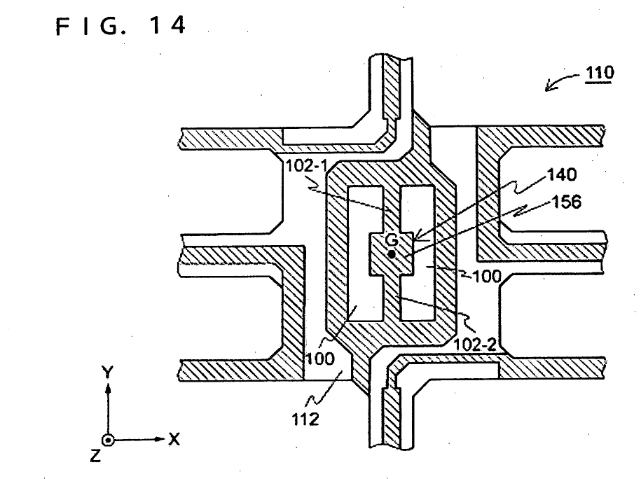

Firstly, the shape of the piezoelectric vibrating segment 110 according to the present embodiment 2 is described. FIGS. 13 and 14 are plan views showing the shape and electrode patterns of the base section 112 of the piezoelectric vibrating segment 110 according to the second embodiment. FIG. 13 shows one principal surface, and FIG. 14 shows the other principal surface. A shape and electrode patterns of each arm section are the same as those of the first embodiment, and accordingly, omitted in FIGS. 13 and 14.

According to FIGS. 13 and 14, the base section 112 of the piezoelectric vibrating segment 110 has a pair of openings 100 formed in the center portion of the base section 112 so as to position across the center point G with each other. And, second beams 102-1, 102-2 with elasticity are formed between the pair of openings, and a second supporting section 140 is formed in the center portion of the whole of the second beams 102-1, 102-2. The center of the second supporting section 140 is substantially identical to the center point G of the piezoelectric vibrating segment 110.

Further, a centerline of the second beams 102-1, 102-2 in the extending direction is identical to a Y axis line passing over the center point G of the piezoelectric vibrating segment. Note that the width and the length of each portion of the second beams 102-1, 102-2 is arranged to provide appropriate elasticity in the Y axis direction.

In FIGS. 13 and 14, the hatched portions indicate electrode patterns. A conduction electrode 156 is formed on a surface of the second supporting section 140. The electrical connections in various portions by the connecting electrodes are the same as in the first exemplary embodiment, and accordingly, the descriptions thereof are omitted.

Hereinafter, a supporting structure for the piezoelectric vibrating segment 110 according to the exemplary embodiment is described.

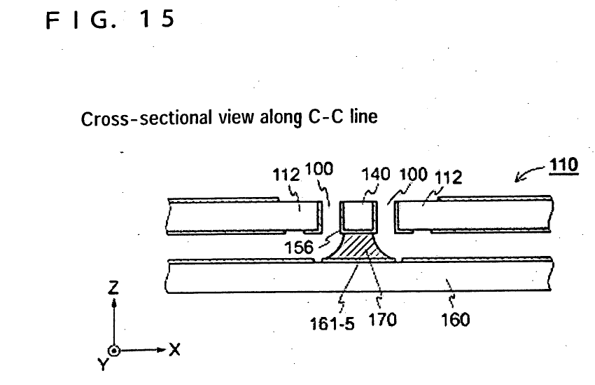

FIG. 15 is a cross-sectional view showing the supporting structure of the piezoelectric vibrating segment 110 according to the embodiment at a position corresponding to the C-C line in FIG. 13. According to FIG. 15, the second supporting section 140 is positioned away from the base section as much as the width of the opening 100 and fixedly adhered to a substrate 160 by conductive adhesive 170. And, the conduction electrode 156 is electrically connected to a vibrating segment mounting electrode land 161-5.

Hereinafter, an operation of the piezoelectric vibrating segment 110 according to the exemplary embodiment is described. FIGS. 16 and 17 are plan views schematically showing vibration forms of the detection vibration in the piezoelectric vibrating segment 110 according to the present embodiment 2. As is the case with FIGS. 10 and 11, each of the vibration arms and beams is illustrated with a line and each of the supporting sections is illustrated with a dot. The vibration form corresponding to the solid lines in FIG. 9 is shown in FIG. 16, and the vibration form corresponding to the broken lines in FIG. 9 is shown in FIG. 17. The same elements as those in FIGS. 13 and 14 are denoted with the same reference numeral, and descriptions thereof are omitted.

According to FIGS. 16 and 17, the periphery of the base section 112 vibrates in rotational directions around the center point G, as is the case with the first embodiment described above. And, the inner edge of the openings 100 to which the second beams 102-1, 102-2 are connected also vibrates in rotational directions around the center point G. In this case, the second beams 102-1, 102-2 can be elastically deformed in rotational directions pivoted on the second supporting section 140.

Therefore, according to the structure of the second exemplary embodiment described above, since the second supporting section 140 formed on the base section 112 is provided in addition to the first supporting sections 30-1 through 30-4 described above, the second supporting section 140 also including the beams 102-1, 102-2 having elasticity, vibrations around base section 112 are absorbed by the beams to reduce propagation of the vibrations to the second supporting section 140. Thus, negative effects to the excited vibrations or the sensing vibrations derived from providing the second supporting section 140 can be reduced.

Hereinafter, a configuration of a third exemplary embodiment of the supporting structure for the piezoelectric vibrating segment according to the invention is described referring to FIGS. 18 and 19. FIGS. 18 and 19 show the structure of a piezoelectric vibrator used for piezoelectric vibrating gyroscopes.

FIG. 18 is a plan view of a piezoelectric vibrator 200 according to the exemplary embodiment with a part of a lid member cut out to see through the inside. FIG. 19 is a cross-sectional view-along the D-D line shown in FIG. 18. The shape of the piezoelectric vibrating segment 10 installed to the structure of the exemplary embodiment is the same as that of the piezoelectric vibrating segment 10 explained as the first embodiment described above.

In FIGS. 18 and 19, the piezoelectric vibrator 200 is formed of the piezoelectric vibrating segment 10 encapsulated in a container composed of a base member 282 and a lid member 284. On the bottom surface of the hollow of the base member 282, there are formed supporting electrodes 260 protruding therefrom, the first supporting sections 30-1, 30-2, 30-3, and 30-4 of the piezoelectric vibrating segment 10 being fixedly adhered to the supporting electrodes 260 by conductive adhesive 270. Further, the second supporting section 40 is fixedly adhered to an electrode land 262 formed on the bottom surface of the hollow of the base member 282 by conductive adhesive 271.

The base member 282 is formed of a laminated ceramics material. The supporting electrodes 260 and the electrode land 262 are respectively connected to external connecting electrodes 264 formed on the outer surface of the base member 282. The supporting electrodes 260 are formed to be higher than the electrode land 262 by, for example, printing only the supporting electrodes 260 a number of times when depositing a material of the electrode land 262 on the ceramics material by screen printing.

Further, the lid member 284 is made of metal and welded to a metal layer formed on the upper surface of the base member 282. The inside of the container composed of the base member 282 and the lid member 284 is maintained vacuum.

The piezoelectric vibrator 200 according to the exemplary embodiment is mounted on a circuit board (not shown in the drawings) forming the piezoelectric vibrating gyroscope. By connecting the external connecting electrodes 264 to a drive circuit or a detection circuit, the piezoelectric vibrating gyroscope can be composed.

Therefore, according to the supporting structure for the piezoelectric vibrating segment 10 of the present embodiment 3 described above, since the conductive adhesive 271 for the second supporting section 40 is thicker than the conductive adhesive 270 for the first supporting section 30-1 through 30-4, and accordingly easy to be deformed in response to the movement of the second supporting section 40, especially to the vibrations of the base section 12 in rotational directions in its plane, negative effects to the excited vibrations or the sensing vibrations derived from fixing the second supporting section 40 can be reduced.

Although in the embodiment, the piezoelectric vibrating segment 10 shown in the first embodiment described above is used as the piezoelectric vibrating segment, the piezoelectric vibrating segment 110 described as the second embodiment can also be used to reduce negative effects to the excited vibrations or the sensing vibrations derived from fixing the second supporting section 140.

Subsequently, another embodiment of the piezoelectric vibrating segment is described referring to the accompanying drawings. FIGS. 20 through 22 show plan views of a piezoelectric vibrating segment of the fourth embodiment according to the present invention. The fourth embodiment is characterized in the shapes of the beams and the shapes of the supporting section formed on the tip of the beams in the piezoelectric vibrating segment 10 (See FIG. 1.) described as the first exemplary embodiment. In FIGS. 20 through 22, the same elements as those of the piezoelectric vibrating segment 10 according to the first exemplary embodiment are denoted with the same reference numerals, and the descriptions therefor are omitted.

A piezoelectric vibrating segment 10A shown in FIG. 20 is provided with four pairs of beams 32A-1 and 32A-2, 32A-3 and 32A-4, 32A-5 and 32A-6, and 32A-7 and 32A-8, each beam having elasticity, and each pair of beams being perpendicular to each other and connected to respective corner of the base section 12, and the first supporting sections 30-1, 30-2, 30-3, and 30-4 being provided on the tip of orthogonal beams in the respective pairs of beams. The second supporting section 40 is provided in the center portion of the base section 12 and is fixed to the substrate 60 as the supporting stage by the conductive adhesive forming a supporting structure similar to that of the first embodiment described above (See FIG. 12.).

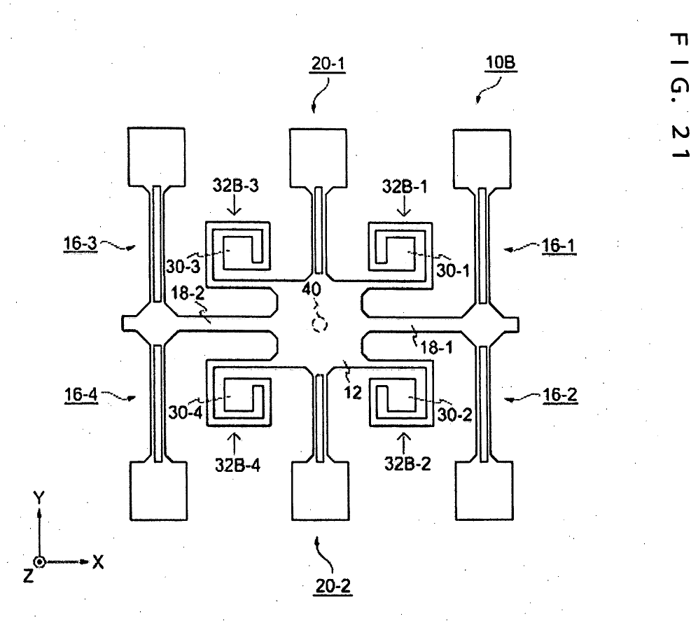

FIG. 21 shows a piezoelectric vibrating segment 10B having differently shaped beams extending from the base section 12. Since all elements other than the beams and the first supporting sections are the same as those in the first embodiment (See FIG. 1.), descriptions for the common elements are omitted, and common reference numerals are used for the common elements. According to FIG. 21, the piezoelectric vibrating segment 10B is provided with beams 32B-1, 32B-2, 32B-3, and 32B-4 connected to the four corners of the base section 12, each continuously formed like a square spiral having sides of four beams. The first supporting sections 30-1, 30-2, 30-3, and 30-4 are formed on the tips of the respective beams and inside the squares formed of the beams. At the center of the base section 12, there is provided the second supporting section 40 that is fixed to the substrate 60 as the supporting stage by the conductive adhesive forming a supporting structure similar to that of the first embodiment described above (See FIG. 12.).

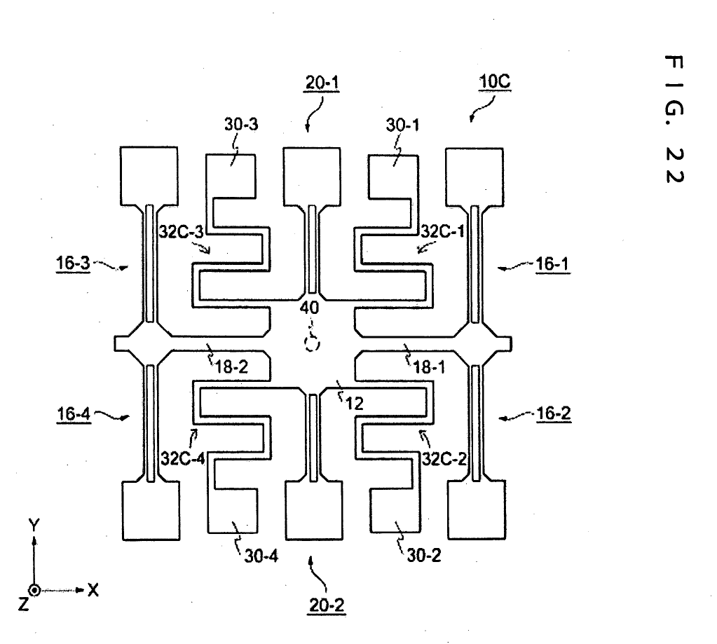

Further, FIG. 22 shows another piezoelectric vibrating segment OC according to the fourth exemplary embodiment. Since all elements other than the beams and the first supporting sections are the same as those in the first embodiment (See FIG. 1.), descriptions for the common elements are omitted, and common reference numerals are used for the common elements. According to FIG. 22, the piezoelectric vibrating segment 10C is provided with beams 32C-1, 32C-2, 32C-3, and 32C-4 shaped like a letter S and connected to the four corners of the base section 12. The first supporting sections 30-1, 30-2, 30-3, and 30-4 shaped like a rectangular are formed at the tips of the beams. At the center of the base section 12, there is provided the second supporting section 40 that is fixed to the substrate 60 as the supporting stage by the conductive adhesive forming a supporting structure similar to that of the first embodiment described above (See FIG. 12.).

Therefore, according to the fourth exemplary embodiment described above, since the length of the elastic portion can be adjusted to make the beams easier to be bent by variously modifying the length or the shape of the beams of the piezoelectric vibrating segments 10A, 10B, and 10C, the vibrations of the base section 12 can be prevented from propagating to the supporting sections without changing the size of the piezoelectric vibrating segment to provide stable excited vibrations or sensing vibrations. Note that, although the second supporting section 40 is the same as that of the second embodiment, the second beams with elasticity can also be used in the base section 12 as is the case with the second embodiment to provide the further stable exited vibrations or sensing vibrations.

Consequently, a fifth exemplary embodiment of the invention is described referring to the accompanying drawings. FIGS. 23 through 25 are plan views of a piezoelectric vibrating segment according to the embodiment. Since the piezoelectric vibrating segment according to the fifth embodiment is characterized in the shapes of the beams and the supporting sections shown in the first embodiment, and all other elements are the same as those in the first exemplary embodiment (See FIG. 1.), descriptions for the common elements are omitted, and common reference numerals are used for the common elements. According to FIG. 23, the piezoelectric vibrating segment 10 is provided with the base section 12 shaped substantially rectangle formed in the center portion thereof, the connecting arms 18-1 and 18-2 extending from edges of the base section 12 opposing each other in the X axis direction, pairs of the excited vibration arms 16-1 and 16-2, 16-3 and 16-4 extending from nearly the tips of the connecting arms 18-1 and 18-2 in the directions perpendicular thereto, and pairs of the weight sections 22-1 and 22-2, 22-3 and 22-4 formed on the tips of the excited vibration arms.

Further, the sensing vibration arms 20-1 and 20-2 extends form a pair of edges of the base section 12 opposing to each other in the Y axis direction, and the weight sections 22-5 and 22-6 shaped substantially rectangle are formed on the tips thereof. The shapes of the base section, excited vibration arms, and the sensing vibration arms described above are the same as those of the piezoelectric vibrating segment 10 of the first exemplary embodiment (shown in FIG. 1). The beams 32-1, 32-2, 32-3, and 32-4 with elasticity whose cross-sectional shapes are rectangular extend from the four corners of the base section 12 parallel to the Y axis. These beams 32-1, 32-2, 32-3, and 32-4 are formed as a shape having continuing cranks and a wider tip portions. The wider tip portions (illustrated by chain double-dashed lines) correspond to the first supporting sections 30-1, 30-2, 30-3, and 30-4 shown in the first embodiment.

Out of the first supporting sections described above, the supporting section 30-1 and the supporting section 30-3 extending in the same direction along the Y axis are connected to a frame section 130, and the other supporting sections 30-2 and 30-4 are connected to a frame section 131, each forming a single body.

Note that piezoelectric vibrating segment 10 is symmetric around the center point G of the base section 12 in both the X direction and the Y direction.

Consequently, a modified example of the piezoelectric vibrating segment 10 according to the fifth embodiment is described referring to the accompanying drawings.

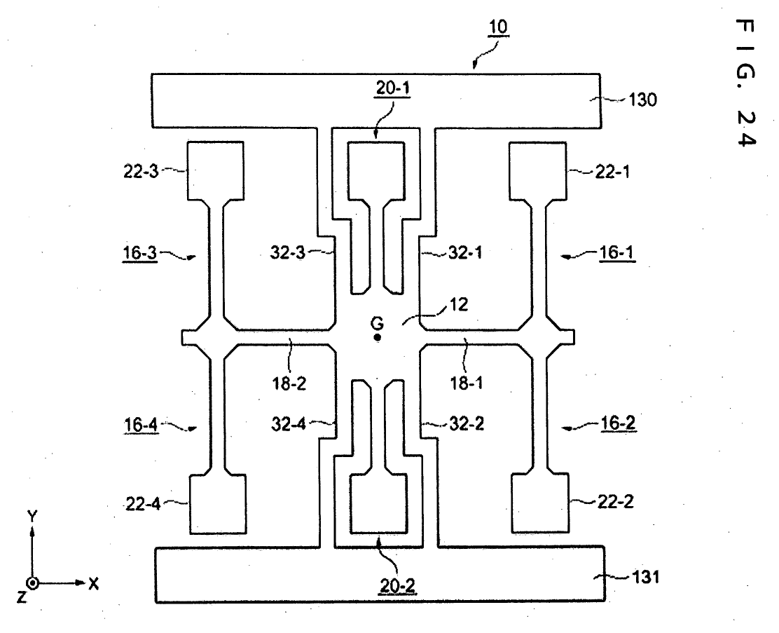

FIG. 24 is a plan view of the piezoelectric vibrating segment 10 according to the modified example of the fifth embodiment. Since the modified example differs from the piezoelectric vibrating segment (See FIG. 23.) according to the fifth embodiment described above only in shapes of the beams extending from the base section, only the different portions are described. According to FIG. 24, the beams 32-1, 32-2, 32-3, and 32-4 having elasticity extend from the four corners of the base section 12 in the Y axis direction. The beams 32-1, 32-2, 32-3, and 32-4 are formed substantially crank. The tips of the beams 32-1 and 32-3 extending in the same direction along the Y axis are connected to the frame section 130, and the tips of the other beams 30-2 and 30-4 in the opposite direction are connected to the frame section 131.

Note that piezoelectric vibrating segment 10 is symmetric around the center point G of the base section 12 in both the X direction and the Y direction.

Hereinafter, another modified example of the piezoelectric vibrating segment 10 according to the fifth embodiment is described referring to the accompanying drawings.

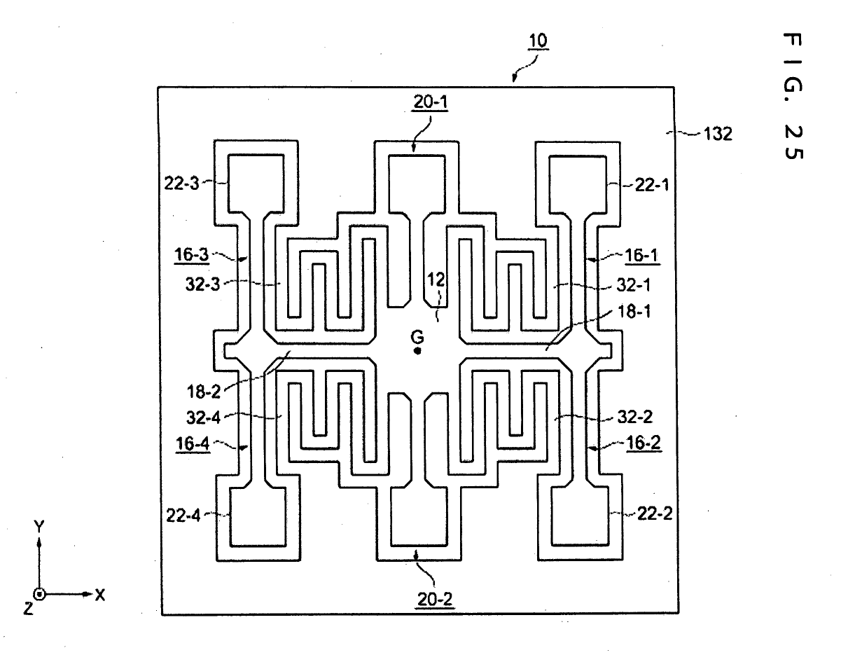

FIG. 25 is a plan view of the piezoelectric vibrating segment 10 according to another modified example of the fifth embodiment. Since the modified example differs from the piezoelectric vibrating segment (See FIG. 23.) according to the fifth embodiment described above only in a shape of the frame, only the different portion is described. The same reference numerals are respectively provided on the common sections. According to FIG. 25, a frame section 132 is formed of a single body surrounding excited vibration arms 16-1, 16-2, 16-3, 16-4 and the sensing vibration arms 20-1, 20-2, and the beams 32-1, 32-2, 32-3, and 32-4 extend from the four corners of the base section 12. The shapes of these beams are the same as the shapes of the beams shown in the fifth embodiment (shown in FIG. 23). The tip portions of the beams continue into the frame section 132.

The gaps between the frame section 132 and the excited vibration arms 16-1 through 16-4, the sensing vibration arms 20-1, 20-2, the beams 32-1 through 32-4 are arranged to be substantially constant. In other words, the gaps between the adjacent sections of the piezoelectric vibrating segment 10 inside the frame section 132 including the frame section 132 are arranged substantially the same. Note that, in the piezoelectric vibrating segment 10 according to the fifth embodiment (See FIG. 23.) described above, the gaps between the sections can be arranged substantially constant, and also in the piezoelectric vibrating segment 10 shown in FIG. 24, the frame sections 130 and 131 can be expanded so as to form the substantially constant gaps with other sections.

Note that piezoelectric vibrating segment 10 is symmetric around the center point G of the base section 12 in both the X direction and the Y direction.

Further, another modified example of the piezoelectric vibrating segment 10 according to the fifth exemplary embodiment is described referring to the accompanying drawings.

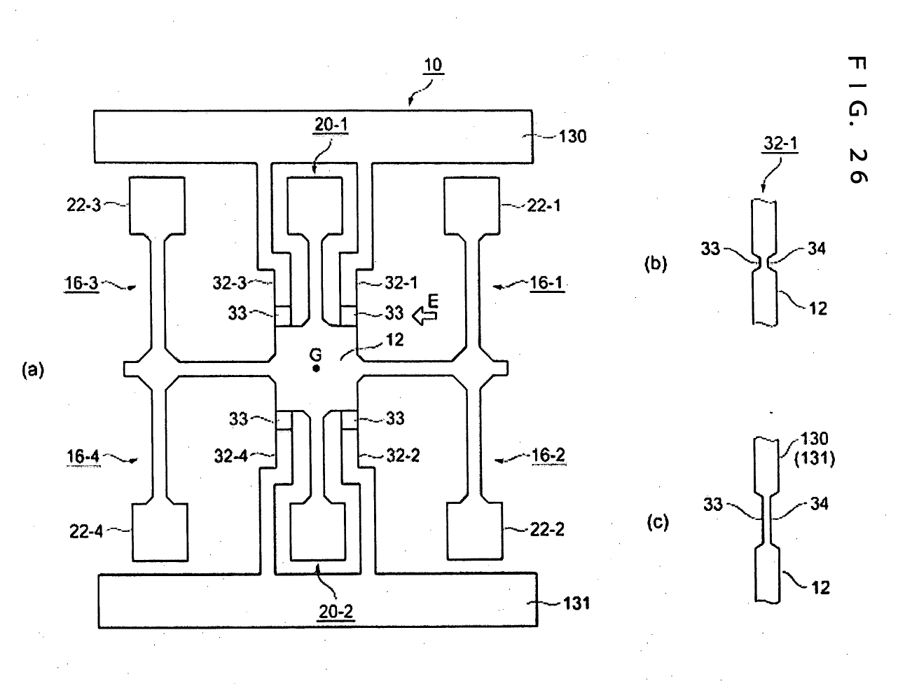

FIG. 26 is a plan view of the piezoelectric vibrating segment 10 according to another modified example of the fifth exemplary embodiment. Since the modified example differs from the piezoelectric vibrating segment (See FIGS. 23 through 25.) according to the fifth exemplary embodiment described above only in a part of cross-sectional shape of the beams, only the different portion is described. Note that, the modified example is described taking the plane shape of the piezoelectric vibrating segment shown in FIG. 24 described above as an example. FIG. 26(a) is a plan view of the piezoelectric vibrating segment according to another modified example of the fifth embodiment, and FIGS. 26(b) and 26(c) are partial cross-sectional views from the arrow E in FIG. ²⁶(a).

According to FIGS. 26(a) and 26(b), the beams 32-1 through 32-4 extend from the four corners of the base section 12 shaped substantially rectangle and provided in the center portion of the piezoelectric vibrating segment 10. In the connection sections of the beams 32-1 through 32-4 with the base section 12, there are provided hollow sections 33 and 34 on both of the principal surfaces of the piezoelectric vibrating segment 10. The hollow sections 33 and 34 are formed from the edges of the base section 12 with a same width as the width of the beams 32-1 through 32-4 and with the remaining thickness of a third of the beams to have lower stiffness.

According to FIG. 26(c), the hollow sections 33 and 34 are formed from the edges of the base section 12 to the connecting sections of the frame sections 130 or 131 with the beams. In other words, the beams 32-1 and 32-2 are formed thinner than the base section 12 or the frame section 130 or 131 to have smaller rigidity.

Note that, the hollow sections 33 and 34 can be applied to the piezoelectric vibrating segments shown in the first embodiment through the fourth embodiment.

Hereinafter, electrode patterns formed on the piezoelectric vibrating segment 10 according to the fifth embodiment described above are described referring to the accompanying drawings.

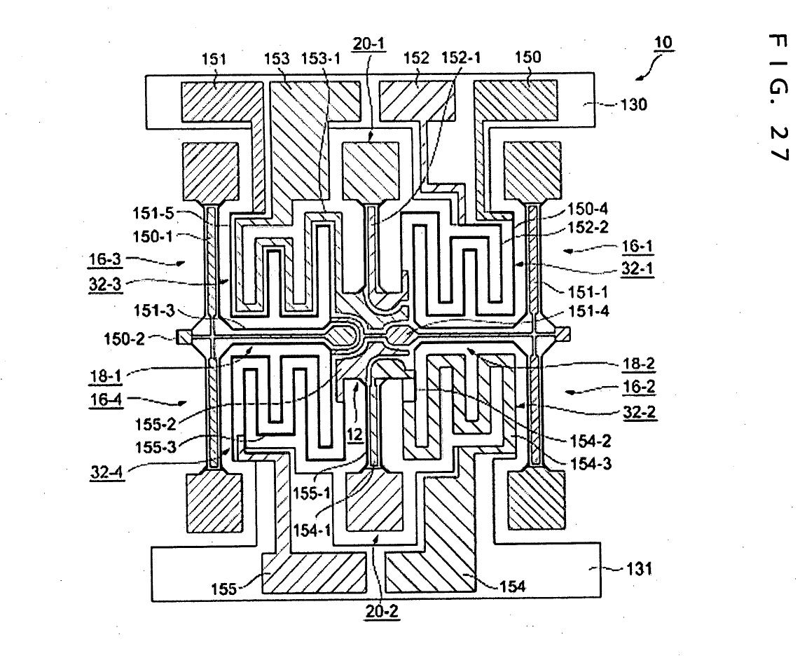

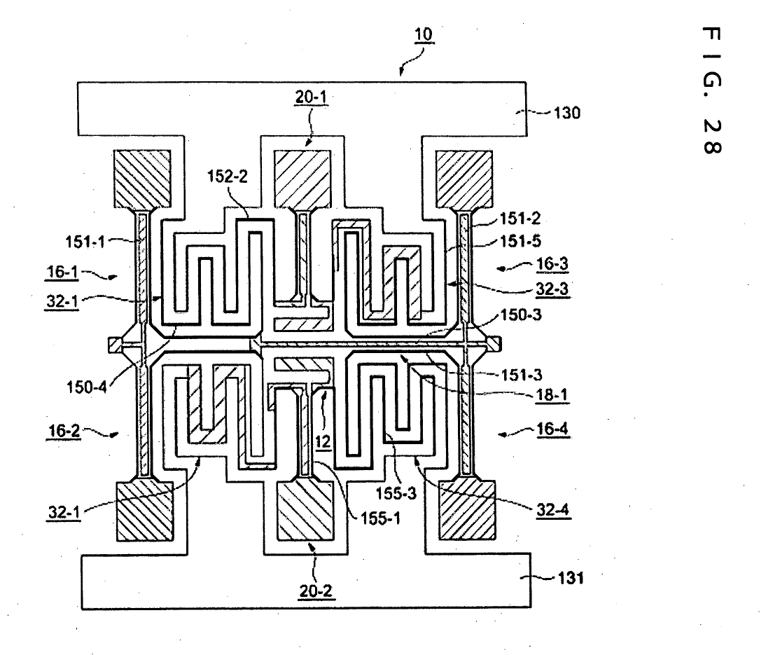

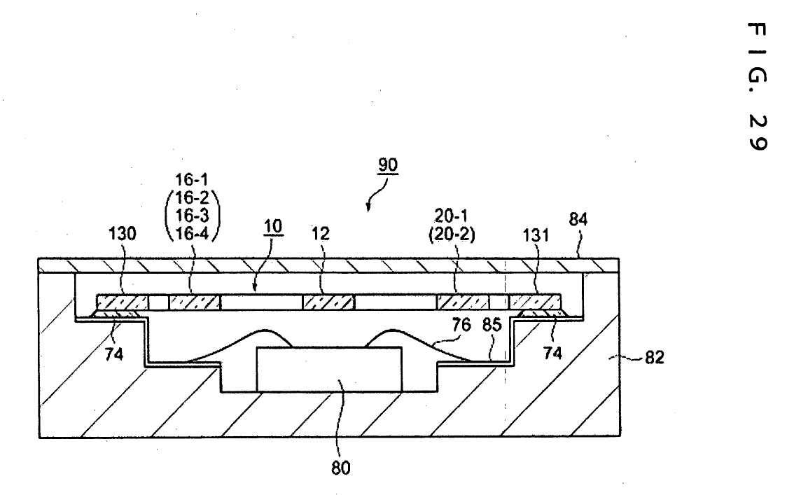

FIGS. 27 and 28 are plan views a structure of the electrode patterns of the piezoelectric vibrating segment 10 according to the fifth exemplary embodiment. FIG. 27 shows one of the principal surfaces (hereinafter referred to as a front surface) facing a base member 82 (See FIG. 29.) described below, and FIG. 28 shows a plan view illustrating the electrode patterns formed on the other principal surface (hereinafter referred to as a reverse surface). Note that, characteristic portions of the fifth exemplary embodiment are mainly described, and other portions can be omitted. In FIGS. 27 and 28, enclosed portions with hatching indicate electrodes formed on the principal surfaces, portions with heavy solid lines indicate electrodes formed on the side surfaces. According to FIGS. 27 and 28, the piezoelectric vibrating segment 10 is provided at least with exciting signal electrodes, exciting signal GND electrodes, first-sensing signal electrodes, first sensing signal GND electrodes, second sensing signal electrodes, and second sensing signal GND electrodes.

The exciting signal electrode can include an electrode pattern 150-1 formed continuously on the front surface of the excited vibration arms 16-3 and 16-4, an electrode pattern 150-3 formed continuously on the reverse surface of the connecting arm 18-1 and the base section 12 and connected to an electrode pattern 150-2 formed continuously on the reverse surface of the excited vibration arms 16-1 and 16-2, and an electrode pattern 150-4 formed on the side surface of the beam 32-1, sequentially connected to a conduction electrode section 150 for the exciting signal formed on the frame section 130.

The exciting signal GND electrode can include an electrode pattern 151-1 formed on the front surface of the excited vibration arms 16-1 and 16-2, an electrode pattern 151-2 formed on the reverse surface of the excited vibration arms 16-3 and 16-4, an electrode pattern 151-3 formed on the side surface of the connecting arm 18-1, an electrode pattern 151-4 formed front surface of the base section 12, and an electrode pattern 151-5 formed on the side surface of the beam 32-3, sequentially connected to a conduction electrode section 151 for the exciting signal GND formed on the frame section 130. Further, the first sensing signal electrode can include an electrode pattern 152-1 formed on the front surface of an arm section of the sensing vibration arm 20-1 and the base section 12 and an electrode pattern 152-2 formed on the side surface of the beam 32-1, sequentially connected to a conduction electrode section 152 of the first sensing signal electrode.

Further, the first sensing signal GND electrode can include an electrode pattern 153-1 formed on the front surface of the base section 12 and the beam 32-1 and continuously connected to a conduction electrode section 153 of the first sensing signal GND electrode.

Further, the second sensing signal electrode can include of an electrode pattern 154-1 formed on the front surface of an arm section of the sensing vibration arm 20-2, an electrode pattern 154-2 formed on the side surface of the beam 32-2, and an electrode pattern 154-3 formed on the front surface of the beam 32-2, sequentially connected to a conduction electrode section 154 of the second sensing signal electrode formed on the front surface of the frame section 131.

Further, the second sensing signal GND electrode is composed of an electrode pattern 155-1 formed on the side surface of an arm section of the sensing vibration arm 20-2, an electrode pattern 155-2 formed on the front-surface of the base section 12, and an electrode pattern 155-3 formed on the side surface of the beam 32-4, sequentially connected to a conduction electrode section 155 of the second sensing signal GND electrode formed on the front surface of the frame section 131.

The piezoelectric vibrating segment 10 having the shape and the electrode pattern structure as described above is encapsulated in the container.

Hereinafter, a supporting structure of the piezoelectric vibrating segment 10 according to the exemplary embodiment and a structure of the piezoelectric vibrating gyroscope 90 using the piezoelectric vibrating segment 10 are described referring to the accompanying drawings.

FIG. 29 is a schematic cross-sectional view of the piezoelectric vibrating gyroscope 90 according to the embodiment. According to FIG. 29, the piezoelectric vibrating gyroscope 90 is composed of the piezoelectric vibrating segment 10 and the semiconductor device 80, both encapsulated in the container formed of the base member 82 and lid member 84. The container formed of the base member 82 and the lid member 84 provides hermetic sealing to maintain inside thereof vacuum.

The base member 82 is formed of laminated ceramics, and is provided with necessary electrode wiring. A metal film can be formed on the upper surface of the periphery of the base member 82, and the lid member 84 made of metal can be welded on the periphery of the upper surface of the base member 82.

The semiconductor device 80 can include a drive circuit for exciting the piezoelectric vibrating segment 10 to vibrate and a detection circuit for detecting the sensing vibration generated at the piezoelectric vibrating segment 10 when a rotational angular velocity is externally applied to the piezoelectric vibrating segment 10 to output an electric signal in accordance the rotational angular velocity.

The semiconductor device 80 is fixed to a surface of the lowest step of the base member 82 and is connected to the electrode wiring 85 formed on the base member 82 via gold wires 76. The electrode wiring is provided at least corresponding to the conduction electrode sections 150 through 155 provided on the piezoelectric vibrating segment 10. The piezoelectric vibrating segment 10 is fixedly adhered to the medium step of the base member 82 at the conduction electrodes 150 through 155 by a conductive adhesive 74. The conductive adhesive 74 has a thickness enough to prevent the piezoelectric vibrating segment form contacting to the base member 82, and the excited vibration arms 16-1 through 16-4, the base section 12, and the sensing vibration arms 20-1, 20-2 are kept floating from the base member.

According to the above structure, the conduction electrode section 150 of the excited vibration electrode formed on the frame section 130 of the piezoelectric vibrating segment 10 described above, the conduction electrode section 151 of the exciting signal GND electrode, the conduction electrode section 152 of the first sensing signal electrode, the conduction electrode section 153 of the first sensing signal GND electrode, the conduction electrode section 154 of the second sensing signal electrode formed on the frame section 131, and the conduction electrode section 155 of the second sensing signal GND electrode are electrically connected to the semiconductor device 80 via electrical wiring of the base member 82 and the gold wires 76. Thus, the piezoelectric vibrating segment 10 is excited to vibrate by the drive circuit of the semiconductor device 80 and outputs the signal of the sensing vibration corresponding to the rotational angular velocity to the detection circuit of the semiconductor device 80. And, the semiconductor device 80 then outputs the electrical signal corresponding to the rotational angular velocity.

Note that, in another modified example of the piezoelectric vibrating segment shown in FIG. 25, as described above, the frame section 132 can be fixed to the medium step of the base member 82.

Further, since the operation of the piezoelectric vibrating segment 10 is the same as that of the first exemplary embodiment (shown in FIGS. 8 through 11, 16, and 17), descriptions are omitted.

Therefore, according to the fifth exemplary embodiment described above, since the supporting sections 30-1, 30-3 and the frame section 130 described above are integrally formed, and the supporting sections 30-2, 30-4 and the frame section 131 are also integrally formed, structural strength of the supporting sections is increased to maintain a more stable posture. Further, since the frame sections and the supporting sections are integrated, the piezoelectric vibrating segment is easy to be handled when encapsulated in the container, as described below, to advantageously improve the operating efficiency.

Further, since the frame sections 130, 131 or the frame section 132 are arranged to have substantially constant gaps with the base section 12, excited vibration arms 16-1 through 16-4, the sensing vibration arms 20-1, 20-2, and the beams 32-1 through 32-4 to provide constant circumferential gaps of the piezoelectric vibrating segment 10 with the surrounding frame sections 130, 131 or the frame section 132, the resist film can be formed in a constant thickness in the resist deposition process of the photolithography process for shaping the piezoelectric vibrating segment 10 by etching. Thus, the shape of each section of the piezoelectric vibrating segment can stably be formed, and, as a result, the excited vibrations and the sensing vibrations can be more stable.

Further, since the hollow sections 33, 34 shaped so as to have smaller stiffness are provided on the part of the beams, vibrations or impacts caused by the environmental condition are hard to propagate from the supporting sections to the base section 12 via beams, and on the contrary, the vibrations of the base section 12 are hard to propagate to the frame sections, to advantageously reduce negative effects applied to the excited vibrations or the sensing vibrations.

Further, as described above, equivalent portions of the supporting sections 30-1 through 30-4 shown in the first embodiment and the frame sections 130, 131 or the frame section 132 are formed integrally. Accordingly, since the exciting signal electrodes and sensing signal electrodes are connected to the conduction electrode sections provided on the frame sections, the electrode forming process can be simplified, and also the operational efficiency in encapsulating the piezoelectric vibrating segment 10 in the container described below can be improved.

Further, since the frame sections 130, 131, and 132 including the supporting sections are fixed to and supported by the base member 82, the piezoelectric vibrating segment can more stably be supported. Further, the piezoelectric vibrating segment 10 can be directly fixed to the base member 82 without the substrate 60 as a supporting stage shown in the first exemplary embodiment, the structure can be simplified to reduce the cost and the size.

Hereinafter, a piezoelectric vibrating gyroscope according to the sixth embodiment of the invention is described referring to the accompanying drawings. In the exemplary embodiment, the fixing structure of the piezoelectric vibrating segment 10 is different from that of the piezoelectric vibrating gyroscope 90 (See FIGS. 12 and 29.) described in the first exemplary embodiment described above or the fifth exemplary embodiment, and the different portions are described.

FIG. 30 is a partial cross-sectional view of the piezoelectric vibrating gyroscope 90 according to the present embodiment 6. According to FIG. 30, the piezoelectric vibrating gyroscope 90 is composed of the piezoelectric vibrating segment 10 and the semiconductor device 80, both encapsulated in the container formed of the base member 82 and lid member 84. The container formed of the base member 82 and the lid member 84 provides hermetic sealing to maintain inside thereof vacuum.

The base member 82 is formed of laminated ceramics, and is provided with necessary electrode wiring. A metal film is formed on the upper surface of the periphery of the base member 82, the piezoelectric vibrating segment 10 provided with a metal film for fixing on the both surface of the frame 132 in the portion where no conduction electrodes are formed is stacked thereon, the lid member 84 is further stacked thereon, and then the base member 82, the piezoelectric vibrating segment 10, and the lid member 84 are fixed in a stacked form by welding or adhesive bonding. The lid member is made of metal, and is provided with a hollow section not to contact with the piezoelectric vibrating segment except the fixing section on the periphery thereof.

The semiconductor device 80 comprises a drive circuit for exciting the piezoelectric vibrating segment 10 to vibrate and a detection circuit for detecting the sensing vibration generated at the piezoelectric vibrating segment 10 when a rotational angular velocity is externally applied to the piezoelectric vibrating segment 10 to output an electric signal in accordance the rotational angular velocity.

The semiconductor device 80 is fixed to a surface of the lowest step of the base member 82 and is connected to the electrode wiring 85 formed on the base member 82 via gold wires 76. The electrode wiring is provided at least corresponding to the conduction electrode sections 150 through 155 provided on the piezoelectric vibrating segment 10. The piezoelectric vibrating segment 10 is fixedly adhered to the medium step of the base member 82 at the conduction electrodes 150 through 155 by a conductive adhesive 74. The conductive adhesive 74 has a thickness enough to prevent the piezoelectric vibrating segment form contacting to the base member 82, and the excited vibration arms 16-1 through 16-4, the base section 12, and the sensing vibration arms 20-1, 20-2 are kept floating from the base member.

Therefore, according to the sixth embodiment described above, since the piezoelectric vibrating segment is pinched to be more firmly fixed by the periphery of the base member 82 and the lid member 84, so called vibration leakage that the vibrations of the excited vibration arms 16-1 through 116-4 or the sensing vibration arms 20-1, 20-2 leak to the base member 82 or the lid member 84 can be reduced to provide more stable excited vibrations or sensing vibrations.

Further, since the height level of the piezoelectric vibrating segment 10 in the cross-sectional view is defined by the step of the base member 82, the gap between the piezoelectric segment 10 and the base member 82 can suitably be arranged to prevent abutting on each other.

Consequently, a seventh exemplary embodiment of the invention is described referring to the accompanying drawings. The seventh embodiment is a partial cross-sectional view showing a structure of the essential part of the piezoelectric vibrator 190 based on the technical idea of the sixth embodiment described above. According to FIG. 31, the piezoelectric vibrator 190 is composed of a base member 182, the piezoelectric vibrating segment 10, and a lid member 184. The base member 182 shapes like a container having a protruded periphery section 182A and is made of ceramics. The lid member 184 also shapes like a container having a protruded periphery section 184A, which is substantially the same shape as the base member 182. The piezoelectric vibrating segment 10 surrounded by the frame section 132 shown in FIG. 25 described in the fifth embodiment is adopted. The conduction electrode sections 150 through 155 (See FIG. 27.) formed on the frame section 132 of the piezoelectric vibrating segment 10 as described above are also formed on the edge surface 132A protruded from the edge portion of the base member 182.

In the piezoelectric vibrating segment 10, although not shown in the drawings, cut-in sections are formed from the periphery of the frame section 132 to the inside the periphery sections 182A and 184 of the base member 182 and the lid member 184, and the conduction electrode sections 150 through 155 are formed on the side surfaces of the cut-in sections and continue to the edge surface 132A. Therefore, no electrodes exist in an area of the frame section 132 where the periphery sections 182A and 184A of the base member 182 and the lid member 184 contact, and the both surfaces of the area are kept flat. Further, a metal layer of a constant thickness is formed in the area of the frame section 132 where the periphery sections 182A and 184A of the base member 182 and the lid member 184 contact.

The base member 182, the piezoelectric vibrating segment 10, and the lid member 184 thus formed are stacked and fixed in a appressed condition by welding or adhesive bonding with vacuum kept inside.

The piezoelectric vibrator 190 thus structured is mounted on a circuit board (not shown in the drawings) forming the piezoelectric vibrating gyroscope. By connecting the conduction electrodes 150 through 155 formed on the edge surface 132A of the piezoelectric vibrating segment 10 to an external drive circuit or an external detection circuit, piezoelectric vibrating gyroscope can be composed.

Therefore, since the piezoelectric-vibrator described in the seventh exemplary embodiment is composed of the piezoelectric vibrating segment 10 stacked with the base member 182 and the lid member 184, a thinner piezoelectric vibrator can be provided. Further, since the conduction electrode sections 150 through 155 are formed on the edge surface of the piezoelectric vibrating segment 10, the external drive circuit or the external detection circuit described above can be connected easily and with a reduced space.

It should be understood that the invention is not limited to the exemplary embodiments described above, and modifications or even improvements that can achieve the object of the invention are included in the invention.

For example, in the piezoelectric vibrating segment of each of the above embodiments, the number of the beams is four and the number of the first supporting sections is four, but different numbers can be applied. Taking the amplitude or directions of the base section of the piezoelectric vibrating segment into consideration, the width, the length, the thickness, the number, or the shape of the first beams can be arranged to provide appropriate elasticity.

Further, the width, the thickness, the length, the number, the extending directions of the beams described in the above embodiments can be properly arranged or selected in accordance with the amplitude or the direction of the vibration of the base section of the piezoelectric vibrating segment.

Further, although the piezoelectric vibration segment 10 of the first exemplary embodiment shown in FIGS. 2 and 3, conduction electrodes 50, 56 are formed on each supporting section and the conduction electrodes 50 56 is connected to the exciting electrode 52 or the sensing electrode 54 formed in the respective vibration arms via connecting electrodes 58-1 through 58-5, the conduction electrodes 50-1 through 50-4, 56 can be omitted. In this case, the base section can be provided with conduction electrodes for connecting to the exciting electrodes 52-1 through 52-4 or the sensing electrodes 54-1 through 54-4, and electrical connection can be provided by gold wires or the like soft enough not to give substantial effects.

Further, although in the supporting structure for the piezoelectric vibration segment shown in the first exemplary embodiment of above, the piezoelectric vibrating segment 10 is fixed to the substrate 60 with the conductive adhesive 70, the piezoelectric vibrating segment according to the present invention can adopt different supporting structure. For example, the first supporting sections 30-1 through 30-4 and the second supporting section 40 can be supported by properly shaped metal lead wires. Regarding the supporting section not necessary to be electrically connected, non-conductive adhesive can be used as well.

Further, although the conductive adhesive is used in the supporting structure for the piezoelectric vibrating segment according to the above embodiment, other materials can be used. For example, the thermo compression bonding with gold balls is applicable. Since the gold balls are used for electrical connections and fixing at the same time and have elasticity, the same effects as the elastic conductive adhesive can be obtained. Further, combinations such that the first supporting sections 30-1 through 30-4 are fixed by the gold balls and the second supporting section 40 or 140 is fixed with a conductive adhesive having a low elastic module.

Further, although in the above embodiments, the piezoelectric vibrating segment having a pair of excited vibration systems extending from the periphery of the base section in opposing directions, and a pair of sensing vibration arms extending in directions perpendicular to the directions in which the excited vibration systems extends are described, it should be understood that the invention is not limited to the piezoelectric vibrating segment thus structured.

For example, the invention is applicable to the tuning fork piezoelectric vibrating segment, or the H piezoelectric vibrating segment having a pair of excited vibration arms extending from the base section in one direction and a pair of sensing vibration arms extending from the base section in the other direction.

Further, although in the above embodiments, the piezoelectric vibrating segment or the piezoelectric vibrator for the piezoelectric vibrating gyroscope are described, the invention can also be applied to the piezoelectric vibrating segment or the piezoelectric vibrator without the function of detecting rotational angular velocity. For example, the invention can be applied to the piezoelectric vibrating segment or the piezoelectric vibrator for a reference clock generator or an acceleration sensor.

Therefore, according to the above first through seven exemplary embodiments, the piezoelectric vibrating segment, the supporting structure for the piezoelectric vibrating segment, the piezoelectric vibrator, and the piezoelectric vibrating gyroscope by which the excited vibrations and the sensing vibrations are kept stable even if vibrations or impacts are applied from the outside, and the excited vibrations and the sensing vibrations are hard to be suppressed even if the piezoelectric vibrating segment is supported can be provided.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

1. A piezoelectric vibrating segment, comprising:
a base section;
a plurality of vibration arms radially extending from the base section in a single plane;
a plurality of first beams having elasticity and extending from the base section and between the vibration arms; and
at least a first supporting section formed on a tip portion of the beams.

2. The piezoelectric vibrating segment according to claim 1,
the first supporting section and a second supporting section being provided on a center of the base section.

3. The piezoelectric vibrating segment according to claim 1,
the first supporting section being formed on a tip portion of the beams;
a pair of openings symmetrically provided with respect to a center of the base section;
a second beam having elasticity and being formed between the openings; and
a second supporting section being provided on a center of the second beam.

4. The piezoelectric vibrating segment according to claim 1, comprising:
an exciting electrode formed on a surface of the vibration arm that excites the piezoelectric vibrating segment to vibrate; and
conduction electrodes formed on a surface of the first supporting section and a surface of the second supporting section, the exciting electrode being coupled to the conduction electrode.

5. The piezoelectric vibrating segment according to claim 4, comprising:
the exciting electrode formed on the surface of the vibration arm; and
a sensing electrode formed on a different position from the exciting electrode that detects a sensing vibration generated in the piezoelectric vibrating segment in accordance with the excited vibration and a rotational angular velocity applied from the outside, the sensing electrode and the exciting electrode being coupled to different ones of the conduction electrodes.

6. The piezoelectric vibrating segment according to claim 1, the first supporting section being continuously formed to a frame section formed around the vibration arms.

7. The piezoelectric vibrating segment according to claim 6, the frame section being formed so as to provide constant gaps with the base section, the vibration arms, and the beams.

8. The piezoelectric vibrating segment according to claim 6, a part of the beam being shaped to have smaller stiffness than the rest.

9. The piezoelectric vibrating segment according to claim 6, the exciting electrode and the sensing electrode formed on the vibration arms being coupled to the conduction electrodes formed on the frame section.

10. A supporting structure for a piezoelectric vibrating segment, comprising:
the piezoelectric vibrating segment according to claim 1;
a supporting stage that oppositely mounts the piezoelectric vibrating segment; and
fixing members provided between the first supporting sections and the supporting stage and between the second supporting section and the supporting stage that fix the piezoelectric vibrating segment.

11. The supporting structure for a piezoelectric vibrating segment according to claim 10, the fixing members being made of a conductive material.

12. A supporting structure for a piezoelectric vibrating segment according to claim 11, the fixing members being made of an elastic material.

13. A supporting structure for a piezoelectric vibrating segment according to claim 10, the fixing member provided between the second supporting section and the supporting stage being thicker than the fixing member provided between the first supporting section and the supporting stage.

14. A supporting structure for a piezoelectric vibrating segment, comprising:
the piezoelectric vibrating segment according to claim 6; and
a base member to which the piezoelectric vibrating segment is fixed,
the frame section formed on the piezoelectric vibrating segment being fixed to the base member.

15. The supporting structure for a piezoelectric vibrating segment according to claim 14, a periphery portion of the frame section of the piezoelectric vibrating segment being fixed to a periphery portion of the base member.

16. A piezoelectric vibrator, comprising:
the piezoelectric vibrating segment according to claim 1;
a base member to which the piezoelectric vibrating segment is fixed; and
a lid member that houses and hermetically seals the piezoelectric vibrating segment in cooperation with the base member.

17. A piezoelectric vibrating gyroscope, comprising:
the piezoelectric vibrating segment according to claim 1;
a drive circuit that excites the piezoelectric vibrating segment to vibrate; and
a detection circuit that detects sensing vibration generated in the piezoelectric vibrating segment in response to application of rotational angular velocity from outside to the piezoelectric vibrating segment.
